(19) United States
(12) Patent Application Publication
(10) Pub. No.: US 2016/0277828 A1
(43) Pub. Date: Sep. 22, 2016

(54) Headphone With Interchangeable Headband Inserts

(71) Applicant: Axel Electronics Inc., Port Washington, NY (US)

(72) Inventors: Sam SangHoon Oh, Old Westbury, NY (US); Seunghee Oh, Roslyn Heights, NY (US); Ho Yong Chung, Flushing, NY (US); Kevin Oh, Old Westbury, NY (US)

(21) Appl. No.: 14/663,410

(22) Filed: Mar. 19, 2015

(51) Int. Cl. H04R 1/10

(52) U.S. Cl. CPC H04R 1/1091

(57) ABSTRACT

Audio headphones for customizing a wearer's headphones by inserting a variety of interchangeable head supports onto a headband of the headphones. The interchangeable head supports may be inserted from above or below the headband and may provide different comfort, design and style headbands. The interchangeable head supports may include a plurality of protrusions that extending from the insert that contact a wearer's head and provide a gap between headband and the user's head.

### TECHNICAL FIELD

The present invention is generally related to headphones, and more particularly is related to a system of headphone assemblies with interchangeable head-support inserts.

### BACKGROUND ART

While users of headphones today, as always, understandably place a premium on the audio performance of their headphones, concerns about fashion, style, comfort, design and appearance are now also always predominant considerations in headphone choice. The personalization options offered by the headphone assemblies with interchangeable head-support inserts described herein address all these considerations.

The headphone assembly with detachable and interchangeable head-support inserts allows a user to customize the look of the headphones to satisfy the style, fashion and comfort demands of today's headphone wearers. Modern headphones have more complex and powerful, and resultantly, heavier components. This can result in an uncomfortable wearing experience. The discomfort sometime arises immediately from poor design, or over time as wearer's fatigue sets in through extended wear and use. Also, a headphone's headband support resting on a user's head can trap body heat causing further discomfort. Another common complaint is that a headphone's headband, while supporting the weight of the headphones, will press down on or flatten a user's hair impacting a user's hairstyle. The resulting “headphone head” is a fashion issue for all but the most follicly challenged, and an occurrence that many headphone users desire to avoid.

The system provides a headphone user the means to personalize the comfort of the headphones on his or her head by selecting a head-support insert that provides the most pleasant experience and delays fatigue from extended wearing of the headphones.

Moreover, the system provides a user the ability to choose a head support that minimized the impact that the headphone headband may have on a well-coifed user's styled hair. Finally, each interchangeable head-support insert provides the headphones with a unique, customizable and stylish appearance.

### BRIEF SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

This summary addresses the above and other needs by providing audio headphones which allow a wearer to customize the headphones by inserting a variety of interchangeable head-support inserts onto a headband of the headphones. The interchangeable head support inserts may include many different designs, colors and materials. In an embodiment, an interchangeable head support can be inserted from above the headband and the head support insert may be configured to envelop the headband from above to provide the appearance that the interchangeable head-support is integral to the headphones as a whole. In another embodiment, the insert may be configured to be inserted from below the headband.

In an embodiment, the headphone assembly may include a headband for reaching over a user's head. The headband may have an upper surface and a lower surface and may also include at least one opening that extends from the upper surface to the lower surface of the opening. The at least one opening may be defined by an opening surface. An insert may be detachably mounted to said headband. The insert may include a connector disposed within the at least one opening between the upper surface and lower surface of the headband and the insert may contact the opening surface when the insert is detachably mounted to the headband. The insert may also include a support disposed between the lower surface of the headband and a user's head when the headphones are worn by a user.

In an embodiment, an opening surface may be generally perpendicular to the headband upper surface. In some embodiments, an opening surface may be generally parallel to the headband upper surface. In certain embodiments, the insert support may comprise a plurality of protrusions extending from the insert support to contact a user's head and provide a gap between said headband and a user's head.

In another embodiment, the headphone assembly may include a headband for reaching over a user's head. The headband may have an upper surface and a lower surface and may also include at least one opening that extends from the upper surface to the lower surface of the opening. The at least one opening may be defined by an opening surface. A head support may be detachably mounted to said headband. The head support may comprise at least one extension sized to fill the at least one opening between the upper surface and lower surface of the headband. The head support may also include a plurality of protrusions disposed between the lower surface of the headband and the user's head when the headphone assembly is worn by a user and may provide a space between the headband and a user's head.

### BRIEF DESCRIPTION OF THE DRAWINGS

The above and other aspects, features and advantages of the present invention will be more apparent from the following more particular description thereof, presented in conjunction with the following drawings. For the purpose of illustrating the invention, exemplary constructions of the invention are shown in the drawings. However, the invention is not limited to the specific methods and instrumentalities disclosed herein.

FIG. 1 is a perspective view of the invention, showing a headphone/headband assembly without an interchangeable head-support insert according to the present invention.

FIG. 1a is an enlarged perspective view, taken from FIG. 1 as indicated, of an embodiment of a headband.

FIG. 1b is an enlarged perspective view, taken from FIG. 1 as indicated, of another embodiment of a headband.

FIG. 2a-f are views from the front, rear, side, opposing side, top, and bottom respectively, of the headphone/headband assembly without an interchangeable head-support insert according to the present invention as illustrated in FIG. 2.

FIG. 3 is a perspective view of a dismounted interchangeable head-support insert according to the present invention.

FIGS. 4a-4f are views from the front, side, opposing side, top, and bottom respectively, of a dismounted interchangeable head-support insert as illustrated in FIG. 3 according to the present invention.

FIG. 5 is a perspective view of the headphone/headband assembly according to the present invention, showing the headphone assembly with a mounted interchangeable head-support insert as illustrated in FIG. 3.

FIG. 6a-d are views from the front, side, opposing side, and top, respectively, of the headphone/headband assembly according to the present invention, showing the headphone assembly with a mounted interchangeable head-support insert as illustrated in FIG. 3.

FIG. 7 is a perspective view of a second embodiment of a dismounted interchangeable head-support insert according to the present invention.

FIG. 8a-f are views from the front, rear, side, opposing side, top, and bottom respectively, of a dismounted interchangeable head-support insert as illustrated in FIG. 7 according to a second embodiment of the present invention.

FIG. 9 is a perspective view of the headphone/headband assembly according to the present invention, showing the headphone/headband assembly with a second embodiment of a mounted interchangeable head-support insert as illustrated in FIG. 7.

FIG. 10a-f are views from the front, rear, side, opposing side, top, and bottom respectively, of the headphone/headband assembly according to the present invention, showing the headphone assembly with a mounted interchangeable head-support insert as illustrated in FIG. 7 according to a second embodiment of the present invention.

FIG. 11 is a perspective view of a third embodiment of a dismounted interchangeable head-support insert according to the present invention.

FIG. 12a-f are views from the front, rear, side, opposing side, top, and bottom respectively, of a dismounted interchangeable head-support insert as illustrated in FIG. 11 according to a third embodiment of the present invention.

FIG. 13 is a perspective view of the headphone/headband assembly according to the present invention, showing the headphone/headband assembly with a third embodiment of a mounted interchangeable head-support insert as illustrated in FIG. 11.

FIG. 14a-f are views from the front, rear, side, opposing side, top, and bottom respectively, of a dismounted interchangeable head-support insert as illustrated in FIG. 11 according to a third embodiment of the present invention.

FIG. 15 is a perspective view of a fourth embodiment of a dismounted interchangeable head-support insert according to the present invention.

FIG. 16a-f are views from the front, rear, side, opposing side, top, and bottom respectively, of a dismounted interchangeable head-support insert as illustrated in FIG. 15 according to a fourth embodiment of the present invention.

FIG. 17 is a perspective view of the headphone/headband assembly according to the present invention, showing the headphone/headband assembly with a fourth embodiment of a mounted interchangeable head-support insert as illustrated in FIG. 15.

FIG. 18a-f are views from the front, rear, side, opposing side, top, and bottom respectively, of a dismounted interchangeable head-support insert as illustrated in FIG. 15 according to a fourth embodiment of the present invention.

FIG. 19 is a perspective view of a fifth embodiment of a dismounted interchangeable head-support insert according to the present invention.

FIG. 20a-f are views from the front, rear, side, opposing side, top, and bottom respectively, of a dismounted interchangeable head-support insert as illustrated in FIG. 19 according to a fifth embodiment of the present invention.

FIG. 21 is a perspective view of the headphone/headband assembly according to the present invention, showing the headphone/headband assembly with a fifth embodiment of a mounted interchangeable head-support insert as illustrated in FIG. 19.

FIG. 22a-f are views from the front, rear, side, opposing side, top, and bottom respectively, of a dismounted interchangeable head-support insert as illustrated in FIG. 19 according to a fifth embodiment of the present invention.

FIG. 23 is a perspective view of a third embodiment of a dismounted interchangeable head-support insert according to the present invention.

FIG. 24a-f are views from the front, rear, side, opposing side, top, and bottom respectively, of a dismounted interchangeable head-support insert as illustrated in FIG. 23 according to a third embodiment of the present invention.

FIG. 25 is a perspective view of the headphone/headband assembly according to the present invention, showing the headphone/headband assembly with a third embodiment of a mounted interchangeable head-support insert as illustrated in FIG. 23.

FIG. 26a-f are views from the front, rear, side, opposing side, top, and bottom respectively, of a dismounted interchangeable head-support insert as illustrated in FIG. 23 according to a third embodiment of the present invention.

Corresponding reference characters indicate corresponding components throughout the several views of the drawings.

### DETAILED DESCRIPTION OF THE DRAWINGS

While the invention herein disclosed has been described by means of specific embodiments and applications thereof, this description is not to be taken in a limiting sense, but is made merely for the purpose of describing one or more preferred embodiments of the invention. Numerous modifications and variations could be made thereto by those skilled in the art without departing from the scope of the invention set forth in the claims. The scope of the invention should be determined with reference to those claims.

### Headband

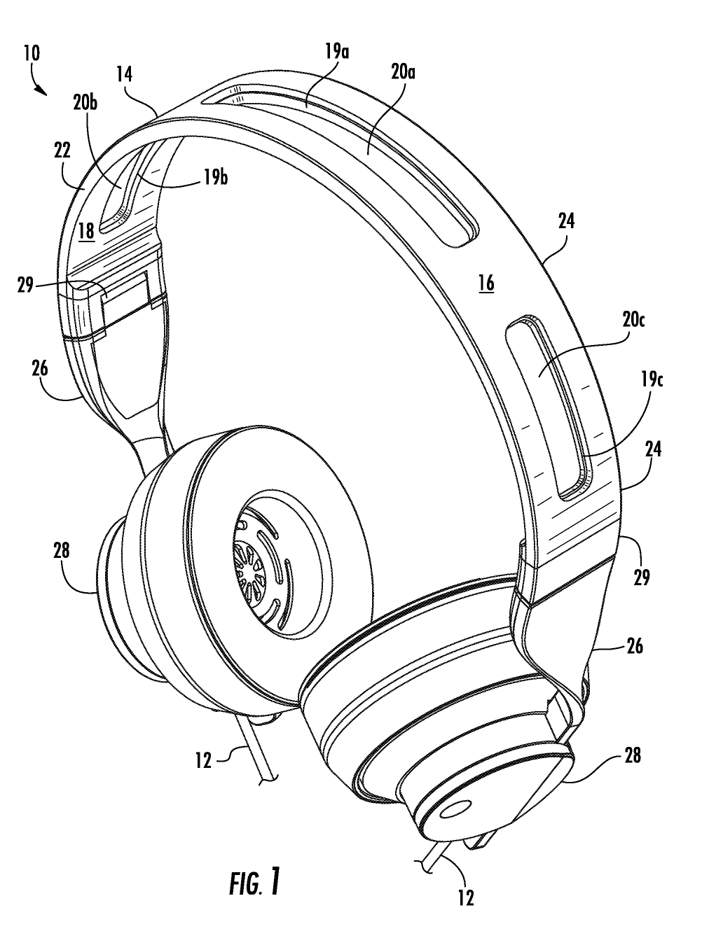

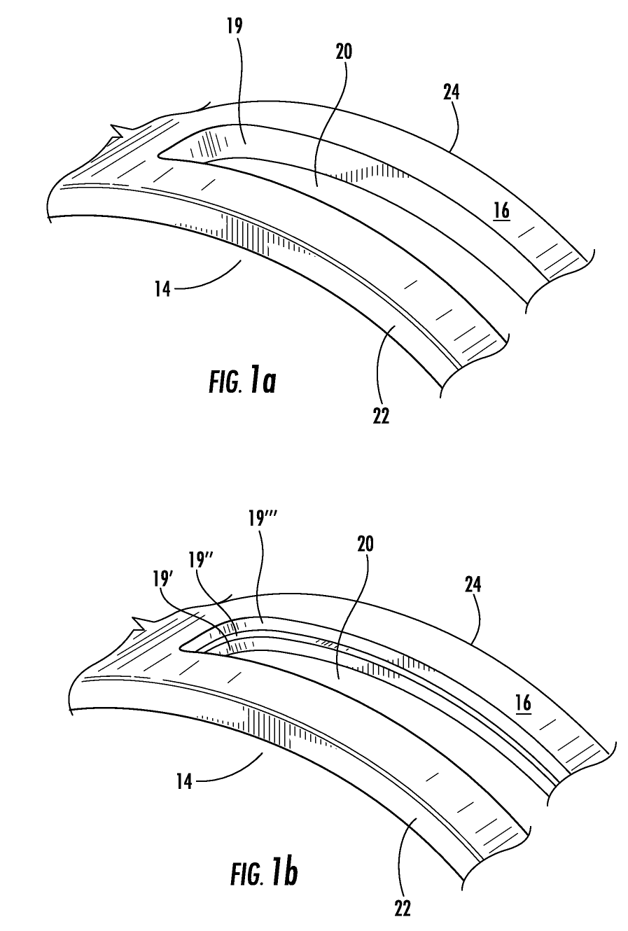

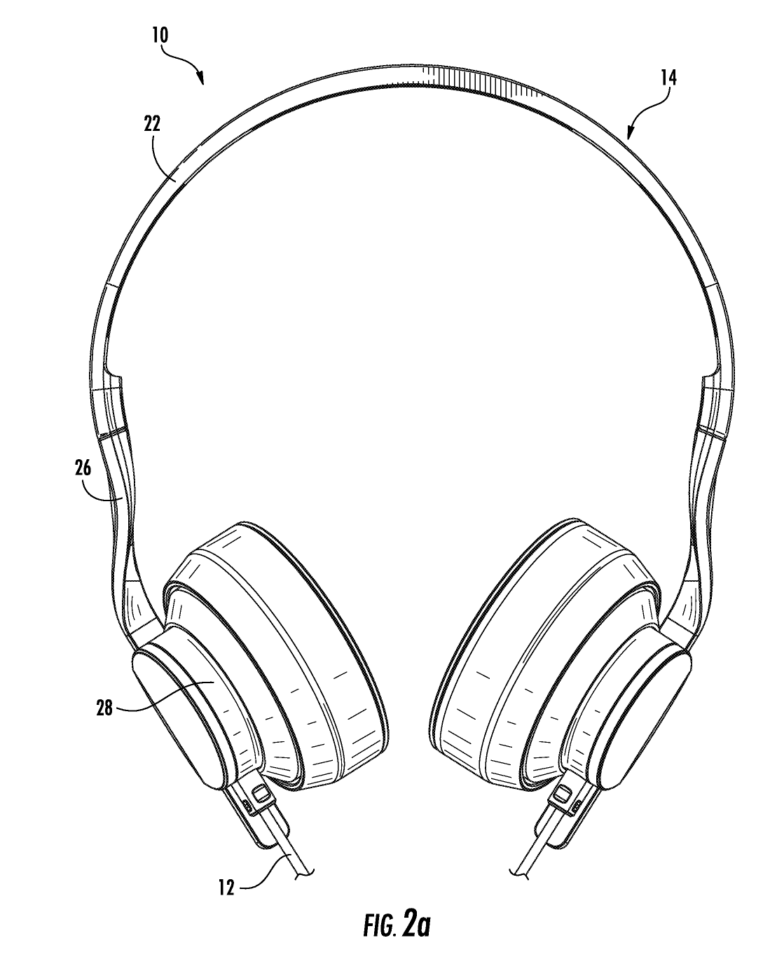

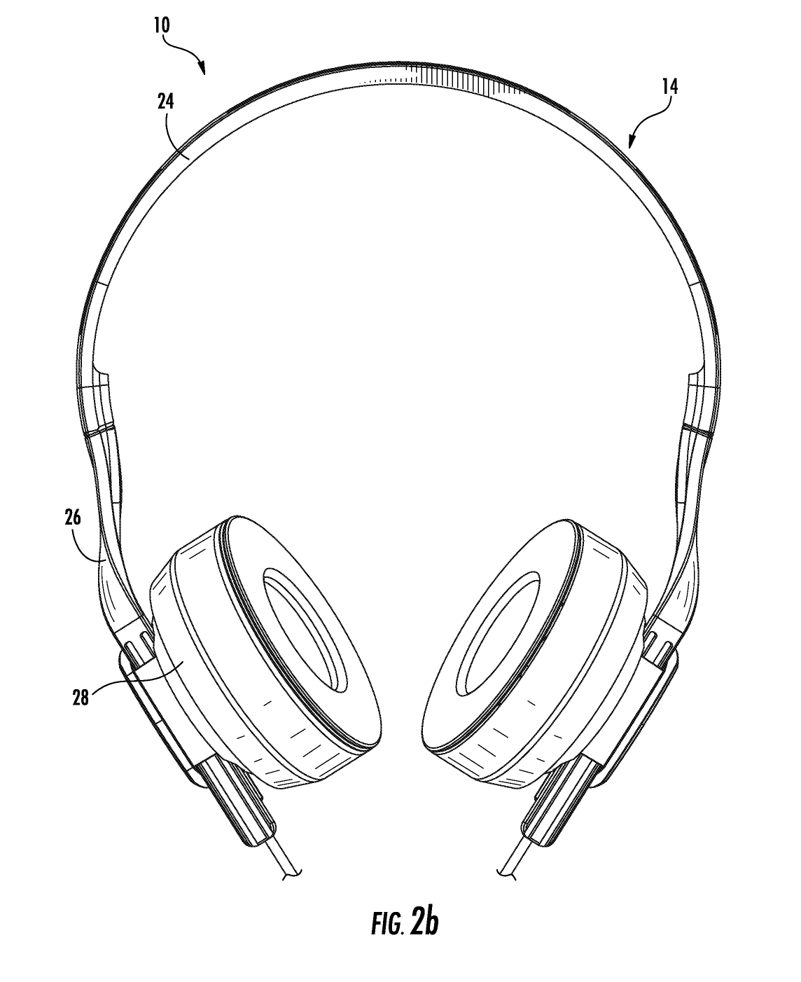

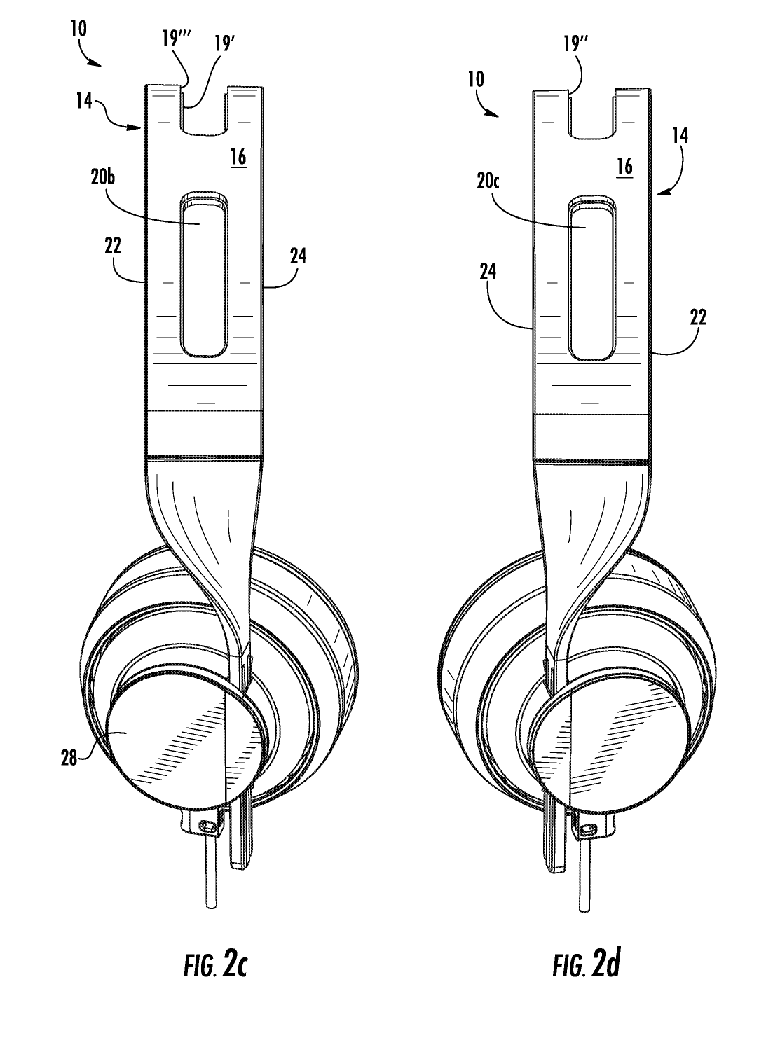

FIG. 1 is a perspective view of the headphone assembly 10 in dissembled form without an interchangeable head-support insert mounted. In addition to an interchangeable head-support insert (not shown in FIG. 1), headphone assembly 10 includes an arced headband 14 for reaching over a wearer's head. The headband 14 may include an upper surface 16 of the headband as well as a lower surface 18. The headband 14 may also include at least one space, slot, or opening 20 passing completely through from the upper surface 16 through to the lower surface 18 of headband 14. Each opening 20 of the headband 14 may be defined by an inner surface 19 of the headband 14. The headband 14 may also comprise a front edge 22 facing towards a user's face, a rear edge 24 towards the back of a user's head, as well as headband ends 26 towards the left and right sides of the headband 14. FIG. 2a-f are views from the front, rear, side, opposing side, top, and bottom respectively, of the headphone/headband assembly without an interchangeable head-support insert as illustrated in FIG. 1.

The headband 14 may be formed of suitably stiff or break-resistant material, such as a hard plastic, hard nylon, metal, wood, other material known in the art for use in headphone headbands. The headband 14 may also be composite, and the headband 14 may be covered in silicone, TPU, leather or fabric, or other appropriate material known in the art, with an appropriate support structure, for a softer or finished effect. The headband 14 may be molded as a single piece, or can comprise multiple pieces. The headband 14 may accommodate a plurality of head-support designs.

A head-support insert may be affixed by insertion through at least one opening 20 formed in the headband 14. An embodiment may include a plurality of openings through which the head-support may be inserted. In an embodiment illustrated in FIG. 1, the headband may comprise three openings 20a-c, a first one centered at the top of the arced headband 20a and two additional openings further along the arced headband 14 to the left 20b and the right 20c of center. Similarly, for each opening 20, the headband may comprise an inner surface 19 defining the opening. For example, in FIG. 1, each of openings 20a-c may be defined by inner surfaces 19a-c.

A head-support insert may be affixed by insertion through at least one opening 20 formed in the headband 14 and may depend on the size and shape of the openings 20 defined by surfaces 19. All ways known and understood by a person of ordinary skill in the art are contemplated for detachably affixing a head-support. Considerations in choosing the size and shape of openings 20 in headband 14 may include the strength and flexibility of the chosen materials or of manufacturing ease. Other considerations may include the ease of insertion and removal of an interchangeable head-support insert for a user as well as the stability of a mounted interchangeable head-support insert.

By way of example, inner surfaces 19 may be parallel around the circumference of an opening 20, defining an opening 20 such that each openings may be the same size and shape at the upper surface 16 through to the lower surface 18 of headband 14. FIG. 1a is an enlargement of such an opening 20 of a headband 14. In other embodiments, opening 20 may larger or smaller at the upper surface 16 than at the lower surface 18 of headband 14. In an embodiment, inner surfaces 19 may define an opening 20 having a frusto-conical or wedge-like shape, such that the opening 20 at upper surface 16 may be larger than, or smaller than, the opening 20 at the lower surface 18 of headband 14 allowing a portion of the insert to be wedged into the opening 20.

In another embodiment shown in the enlargement of a portion on the headband 14 in FIG. 1b, the opening 20 may be larger at the upper surface 16 than at the lower surface 18 of headband 14, where the opening 20 is defined by inner surface 19 shaped like a countersink (not shown) or a counterbore. As illustrated in FIG. 1b, opening 20 may be defined by a substantially vertical inner surface 19′ closer to lower surface 18 where opening 20 is more narrow, and a substantially horizontal inner surface 19″, and another substantially vertical surface 19′″ closer to upper surface 16 where the opening 20 is less narrow.

Also, the number of openings 20 may vary by design choices by one of skill in the art. Considerations in choosing the number of openings 20 in headband 14 may include the strength and flexibility of the chosen materials or of manufacturing ease. Other considerations may include the ease of insertion and removal of an interchangeable head-support insert for a user as well as the stability of a mounted interchangeable head-support insert.

The headphone assembly may also include two ear pieces 28 providing audio output through speakers and surrounding a wearer's ears. The ear pieces 28 may be attached to the headband 14 at or near the headband ends 26. The headband ends 26 and ear pieces 28 are configure to allow placement adjustment for a wearer to comfortably position the ear pieces 28. The headband ends 26 are also configured to allow the ear cups 28 to be removed and exchanged with other ear cups of different shape, style, sound, or size. Ear cups 28 are not meant to be a limitation herein with respect to an output device, as other output devices that may be know in the art are contemplated. The ear cups 28 may be configured to accommodate removable or interchangeable audio cables 12.

At or near the headband ends 26, may be hinges 29 that may allow a user to fold the headband 14. The hinges may be positioned on the headband at a point above where the ear cups may attach, allowing a user the benefit of folding the headband while the ear cups are mounted. The hinges 29 may be configured so that the headband ends 26 are folded inward into the center of the U-shape of the unfolded headband 14.

Interchangeable head-support inserts for use with a headband 14 and a headphone assembly 10 as illustrated in FIG. 1 may be designed to be detachably mounted to a headband and to provide a support for a wearer's head while wearing the headphone assembly 10. The interchangeable head-support inserts may be removable and interchangeable with other interchangeable head-support inserts to allow the wearer to change the appearance, comfort, design, and style of the headphone assembly 10. The interchangeable head-support inserts may be designed to be top mounted or bottom mounted onto the headband 14. In an embodiment, the interchangeable head-support inserts may be molded as one piece, but it is contemplated that a head-support insert may be comprised of multiple pieces and of a composite design.

When mounted on a headband 14, interchangeable head-support inserts may protrude through the openings 20 of the headband 14. The interchangeable head-support inserts may also contact the upper surface 16 of the headband and/or the lower surface 18 of the headband, as well as the inner surfaces 19 of the headband openings 20, which may help secure the head-support insert to the headband 14.

The detachable and interchangeable head-support inserts may be disposed under the headphone's headband 14 to cushion or support the headphone assembly on a wearer's head. A user can select and attach a head-support insert that provides a chosen combination of comfort, fashion, appearance and style. The head-support insert may be configured to act simply as a cushion for the user, providing a comfortable user experience. The head-support insert may also be configured to reduce user fatigue from wearing the headphones for extended periods of time by minimizing contact points with a user's head. It can also provide ventilation to a user's head, by providing space between the head and the headband14, extending the duration of time a user's can comfortably wear the headphones. The head-support insert below the headband 14 may also be configured to maintain a distance between the headband and a user's hair to minimize any disturbance to a user's styled hair. These effects may be achieved by the design choices in forming various interchangeable head-support inserts.

### Top Mounted Interchangeable Head Support Insert Embodiments

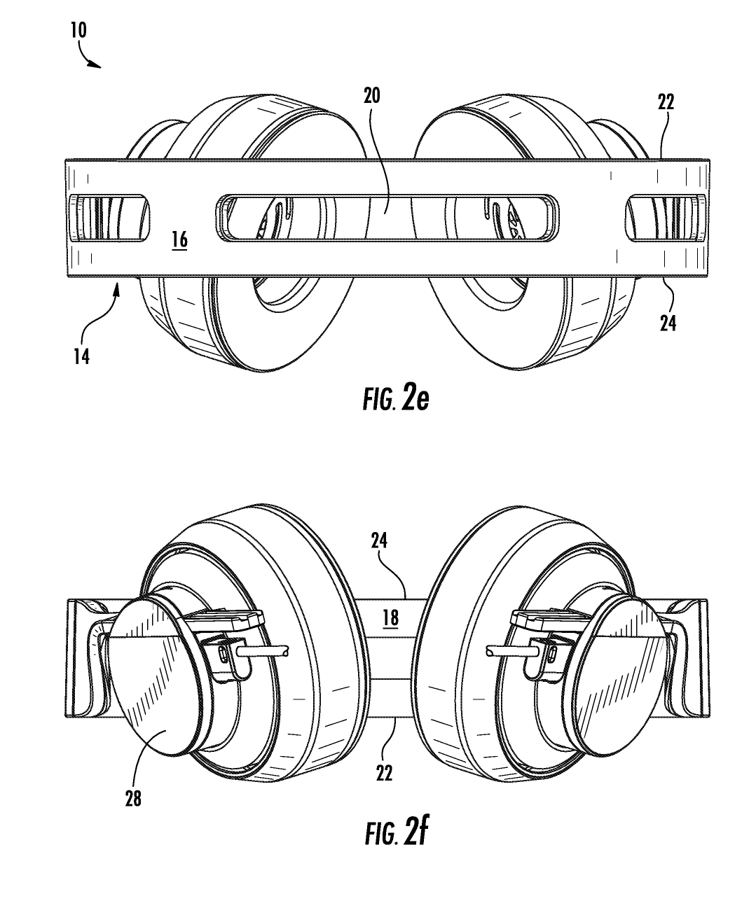

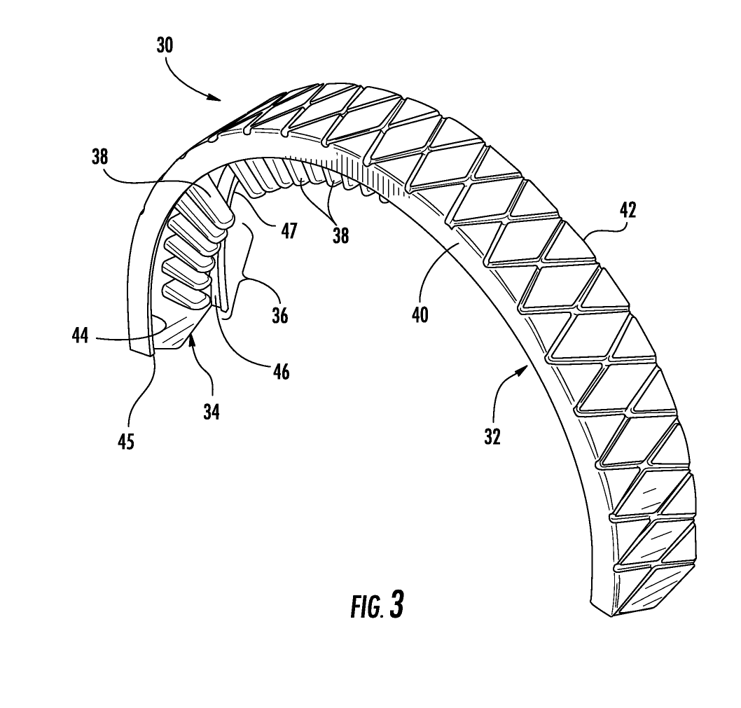

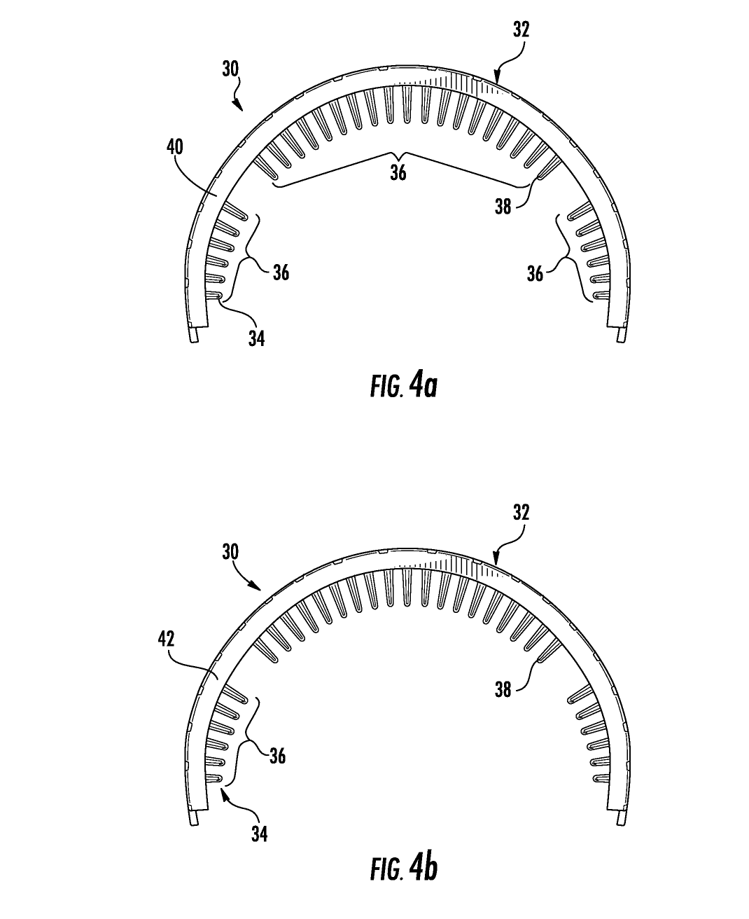

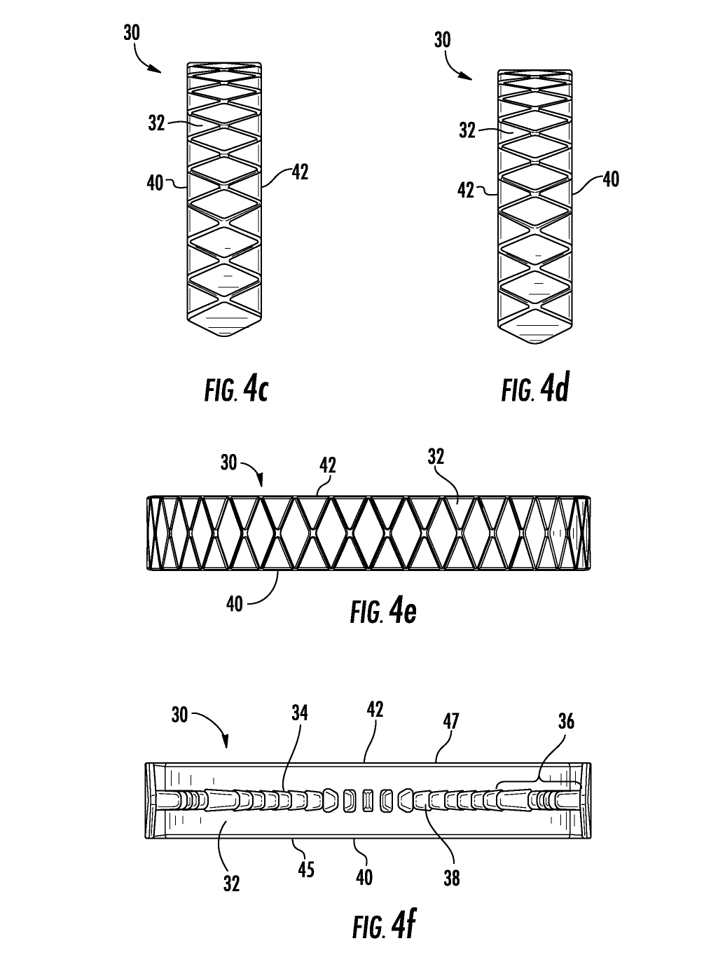

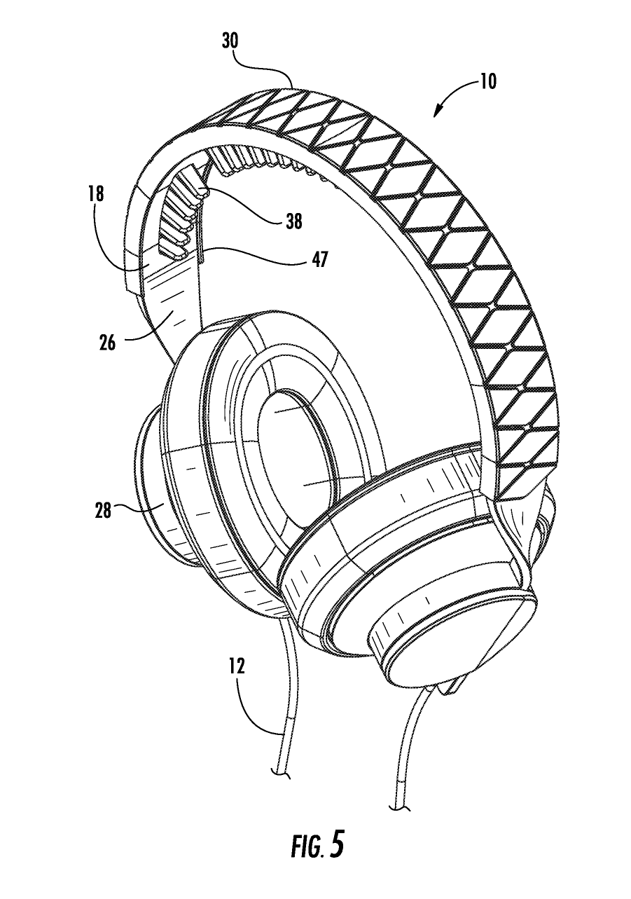

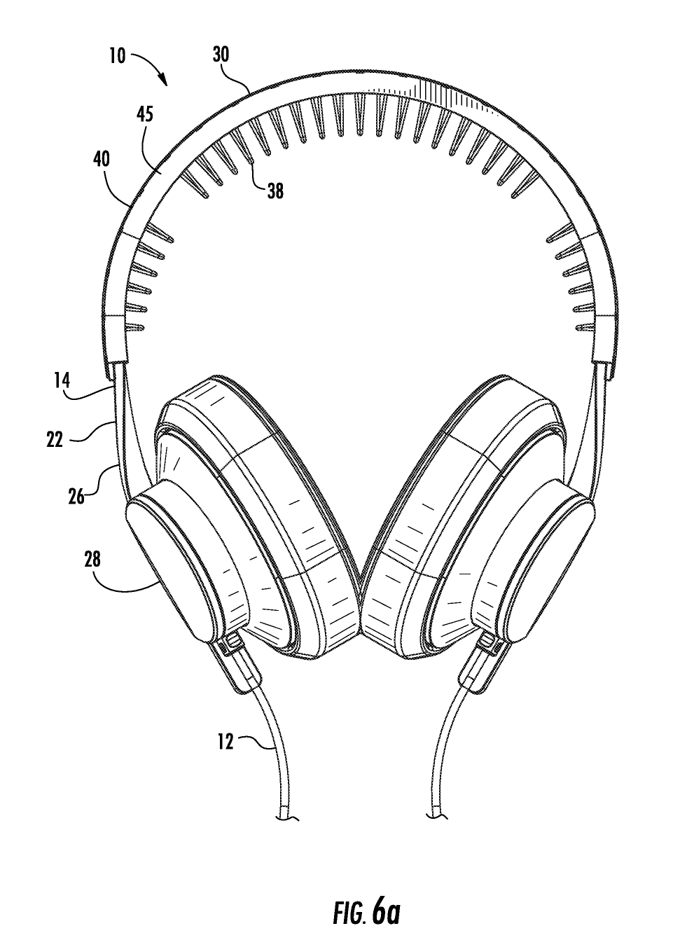

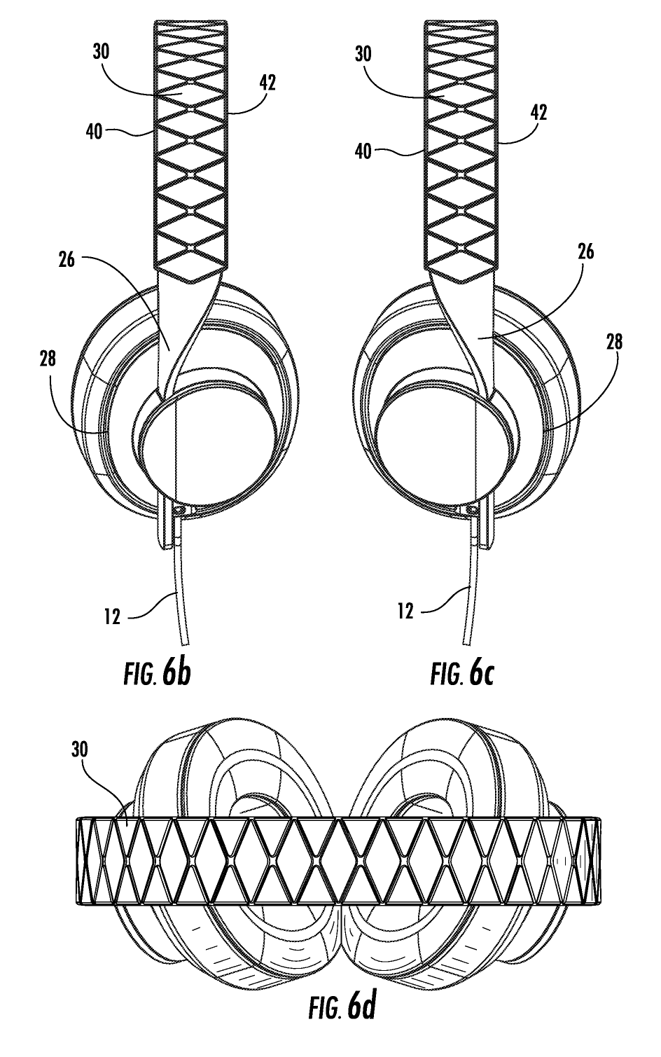

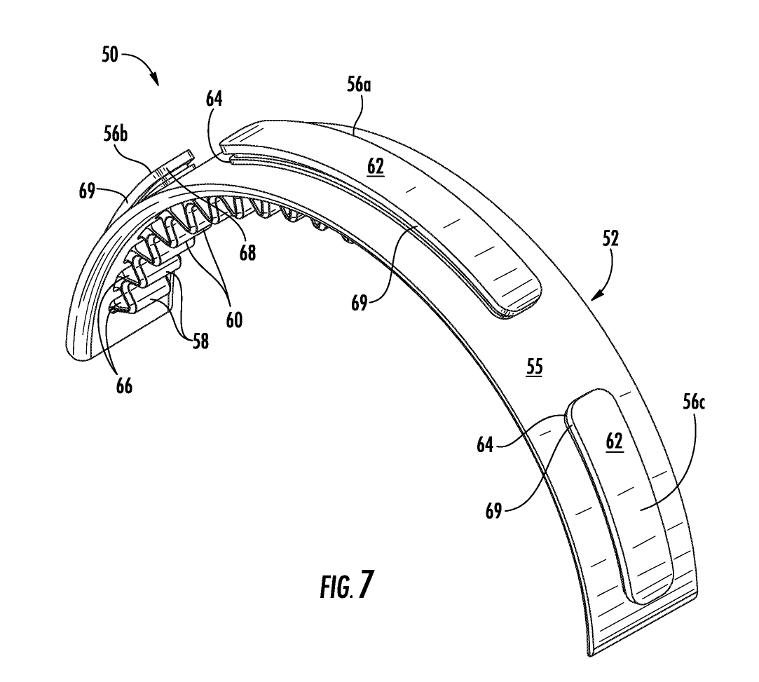

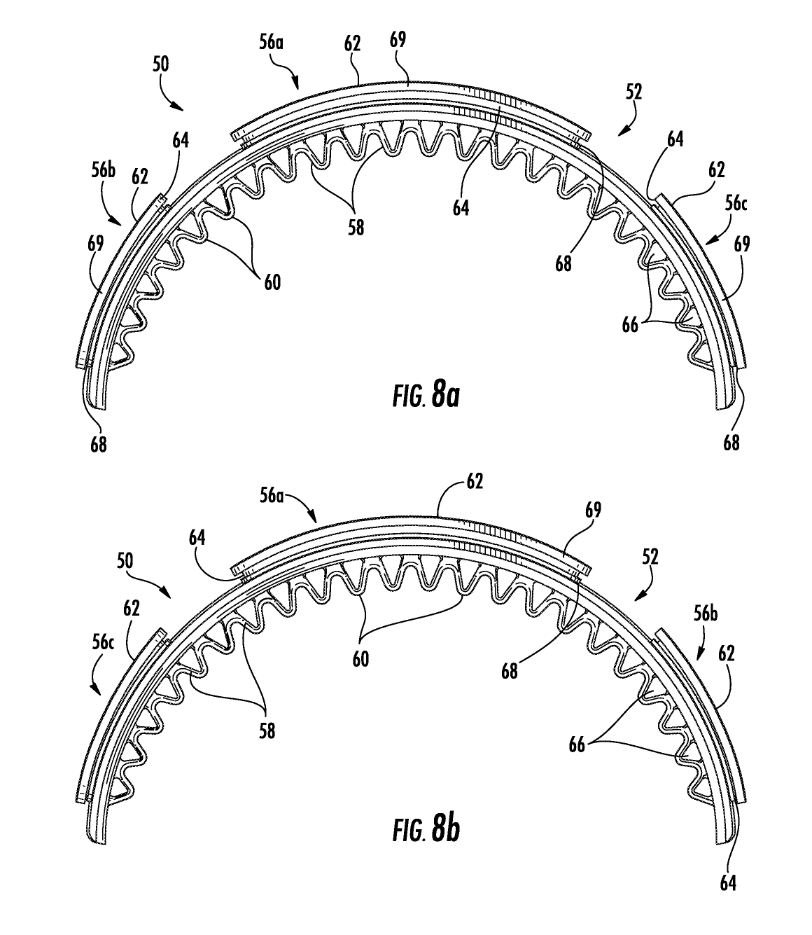

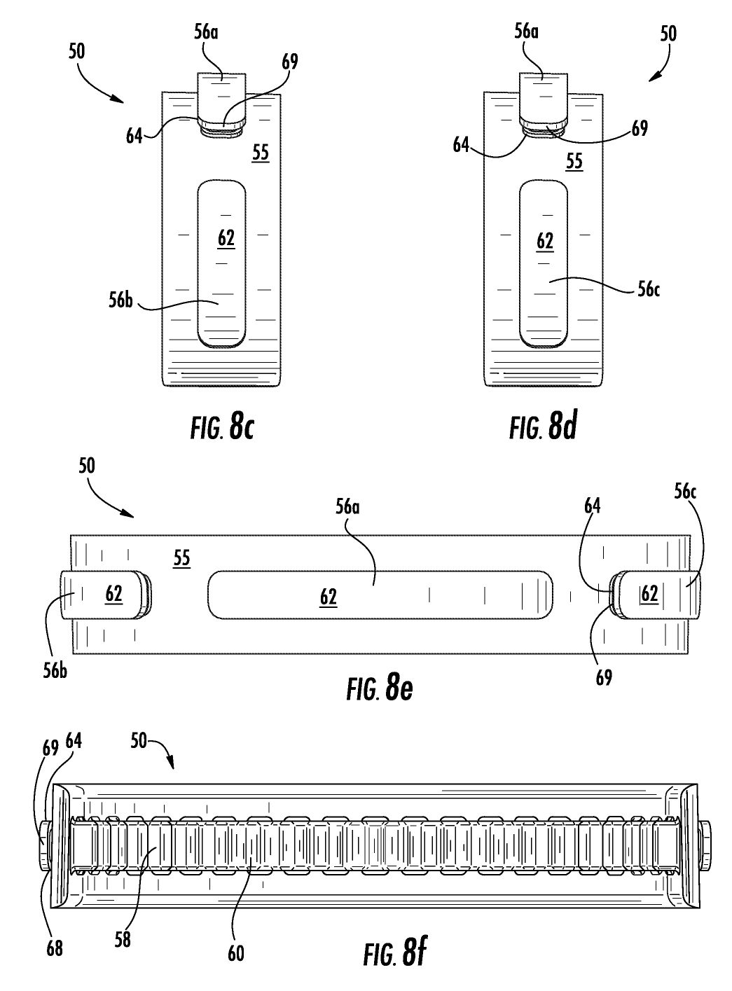

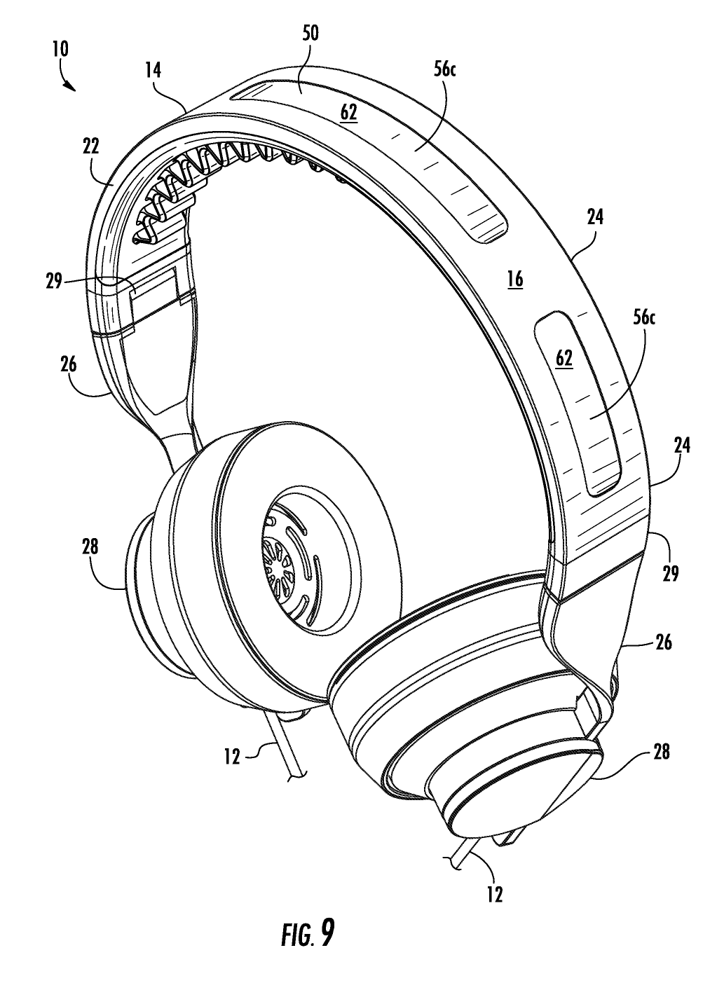

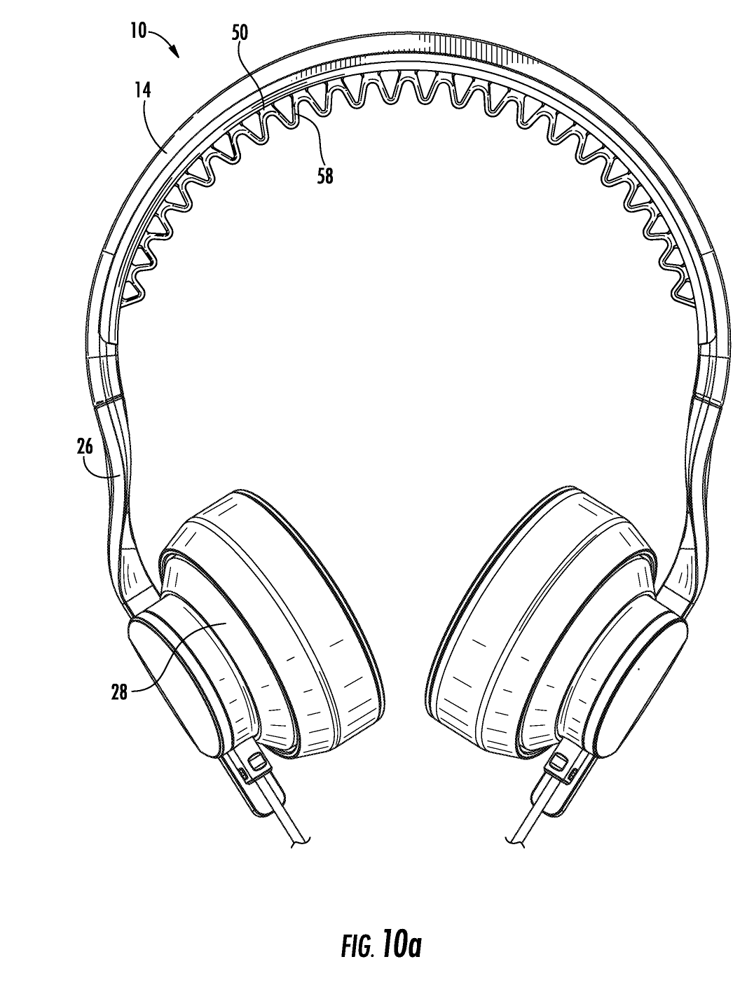

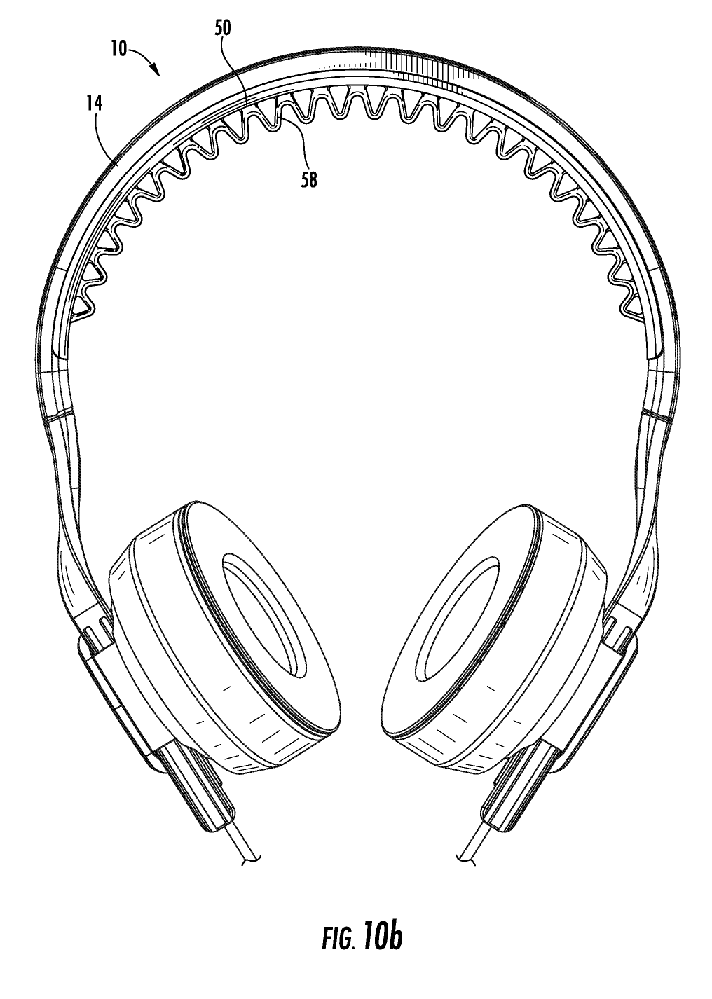

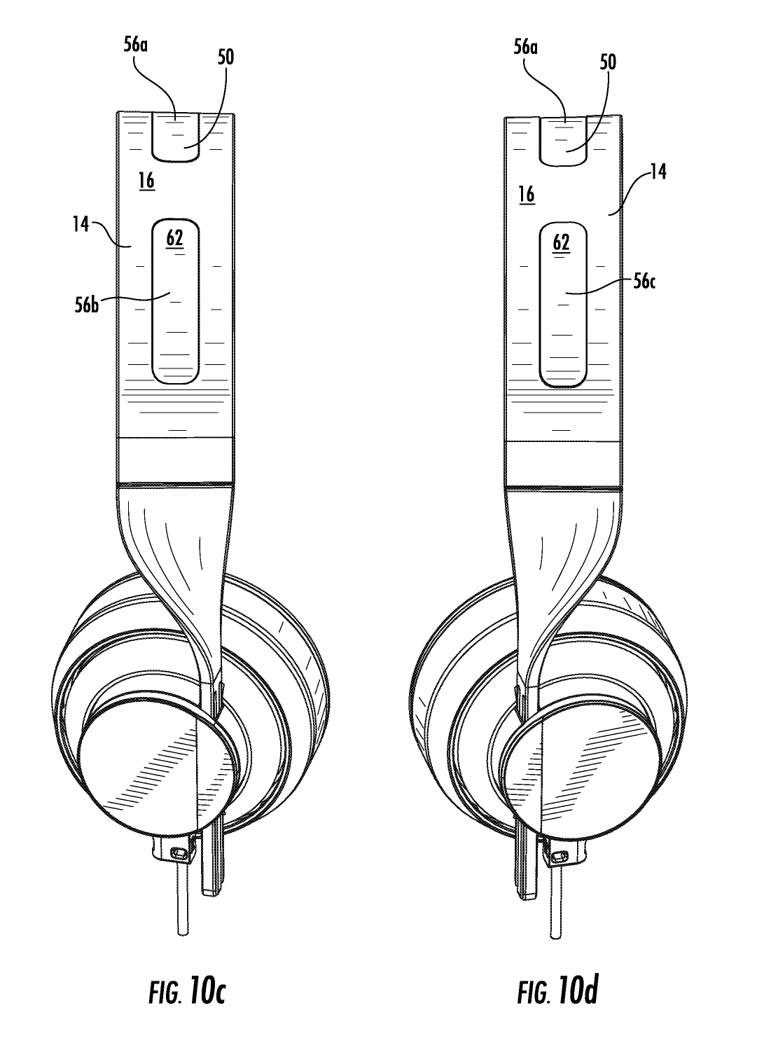

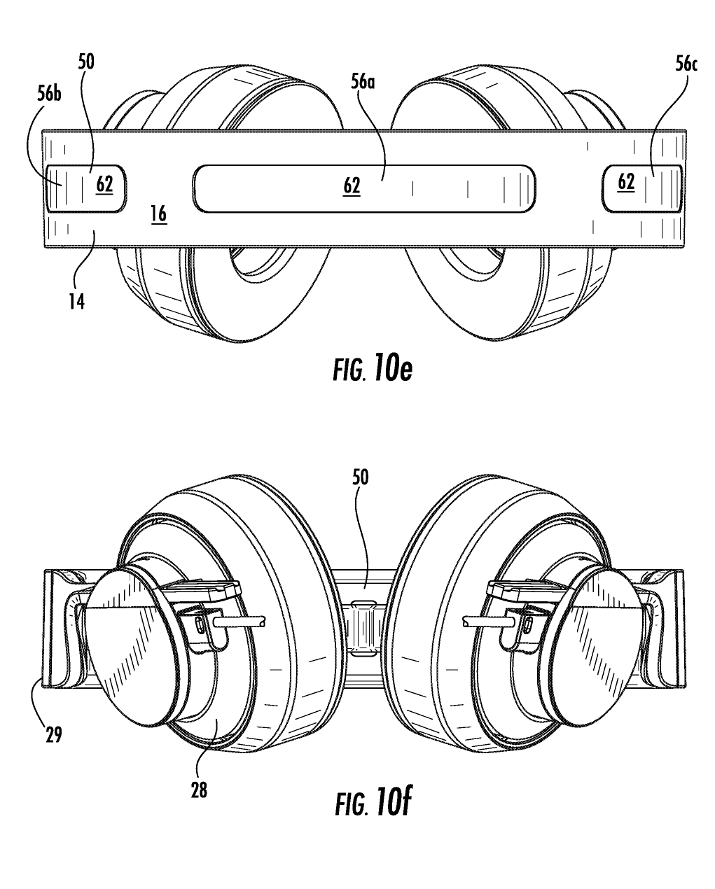

In FIGS. 3-6, an interchangeable head-support insert 30 shown is configured to be insertable from above the headband 14. In this embodiment, the interchangeable head-support insert 30 may comprise an upper section 32 which may contact upper surface 16 of the headband 14 when mounted. The lower section support 34 may comprise the part of the headphone assembly 10 that contacts the wearer's head and acts as the support for the headphone assembly 10 while worn by a user.

The lower section support 34 may comprise protrusions 36 which can be inserted through the openings 20 of the headband 14 and extend to below the lower surface 18 of the headband 14 when mounting the interchangeable head-support insert 30 shown in FIGS. 3-6. These protrusions 36, in a top-mounted embodiment, may also serve as the physical head supports. The protrusions 36 may act as cushions for the user, providing a comfortable user experience while wearing the headphones 10. The protrusions 36 may also be configured to reduce user fatigue from wearing the headphones for extended periods of time. The protrusion 36 may also be configured to maintain a gap between the headband 14 and a user's head to minimize disturbance to a user's styled hair or to provide cooling ventilation. In FIGS. 3-6, the protrusions 36 may be formed in a shape similar in appearance to the teeth of a comb 38, by way of example of a design for the protrusions 36.

The protrusions 36 may be made up of individual teeth 38, that may be formed of a pliant or flexible material so that the weight of the headband may rest on the tips of the teeth 38. This may allow the headband to be suspended above the user's head. In this embodiment, the teeth made of a pliant material may maintain a desired distance between the headband and a user's head to minimize disturbance to a user's styled hair. The resulting fit may provide a user with extended periods of use while avoiding “headphone head”. The depth, shape, spacing and pliancy of the teeth 38 may be considered by a designer of a head-support insert to allow a user to achieve a desired comfort, fashion, appearance and style in its headphones.

The teeth 38 are also contemplated to be made of a hard or inflexible material and interact with a user's hair in a similar fashion to a combed headband fashion accessory. In this case, the headphone headband could have the same effect on a user's hair as a typical hair accessory that may otherwise be chosen to be worn, and again avoiding “headphone head”.

Referring again to the top mounted interchangeable head-support insert 30 illustrated in FIGS. 3-6, the upper section 32 may be formed to envelop the upper surface 16 of the headband 14 from above. In this way, upper section 32 may be designed to provide the appearance that the interchangeable head-support insert 30 is integral to the headband 14 and the headphone 10 as a whole, rather than giving the appearance of being an insert. The top mounted interchangeable head-support insert 30 may incorporate different colors, patterns, writings, numbers, designs, logos, and any combination thereof.

A head support insert may be attached to a headband 14 of the headphone assembly 10 in a variety of ways. The upper section 32 of the top mounted interchangeable head-support insert 30 illustrated in FIGS. 3-6 may also be formed to detachably secure the interchangeable head-support insert 30 to the headband 14 when mounted. The upper section 32 of the insert 30 may comprise a front edge 40 and a rear edge 42 that may overlay and envelop the front and rear edges 22,24 of the headband 14. The upper section 32 may comprise grooves or channels 44,46 along and below the front and rear edges 40, 42 of the insert 30 which can accommodate the front and rear edges 22,24 of the headband 14, respectively when mounted. Channels 44,46 may be formed in part by a lip 45,47 that protrudes inward from the front and rear edges 40,42 of the insert 30 and extend along the lower surface 18 of the headband 14 on both the front and rear edges 40,42 of the insert 30 when mounted. The upper section front and rear channels 44,46 thus may serve to detachably secure the top mounted detachable head-support insert 30 in place on the headband 14. A friction, click, compression, or other appropriate fit may also be formed by the interplay between front and rear channels 44,46 and the front and rear edges 22, 24 of the headband to detachably secure the interchangeable head-support insert 30 to the headband 14,with the exact nature of the fit depending on the pliability and frictional coefficient of the materials used for the top mounted interchangeable head-support insert 30 and the headband 14. It is contemplated that the fit may be sufficient to maintain the insert 30 in the headband 14 during use, but provide a user the ability to remove and reinsert the detachable head-support 30 with a desired ease.

Referring again to the top mounted interchangeable head-support insert 30 illustrated in FIGS. 3-6, the lower section support 34 may also be formed to detachably secure the interchangeable head-support insert 30 to the headband 14 when mounted. The lower section support 34 may contact the inner surfaces 19a-c defining the openings 20a-c (where three openings 20 are provided in a headband 14) of the headband 14. If the protrusions 36 are made of a compressible material, this contact may form a compression-like fit to detachably secure the interchangeable head-support insert 30 to the headband 14 when mounted. While a less compressible insert could be similarly detachably secured by also forming a friction or compression like fit with surface 19. In the embodiment illustrated in FIGS. 3-6, the support teeth 38 are wedge shaped, which may increase a friction or compression like fit with surface 19 to also detachably secure the interchangeable head-support insert 30 to the headband 14 when mounted.

The lower section support 34 may also comprise a surface (not shown) that may contact the lower surface 18 of the headband 14. This lower contact on lower surface 18, acting in conjunction with the upper section 32 contact on the upper surface 16 of the headband 14 when mounted, may serve to provide a compression or click-like fit to also detachably secure the interchangeable head-support insert 30 to the headband 14. The exact nature of the fit is dependent on the pliability of the material used for the top mounted interchangeable head-support insert 30.

### Bottom Mounted Interchangeable Head Support Insert Embodiments

The interchangeable head-support inserts may be designed to be bottom mounted onto the headband 14 as well. A number of embodiments of bottom-mounted inserts are described herein. Each bottom mounted interchangeable head-support insert illustrated may be configured to be mountable from below the headband 14 and have a lower section support that may comprise the part of the headphone assembly 10 that contacts the user's head and act as the support of the headphone assembly 10 while worn by a user and an upper section may comprise protrusions that extend from below the lower surface 18 of the headband 14 through the openings 20 in the headband when mounted on the headband 14 which may detachably secure the bottom mounted interchangeable head-support insert to headband 14. The number of protrusions may be equal to the number of openings 20 in the headband.

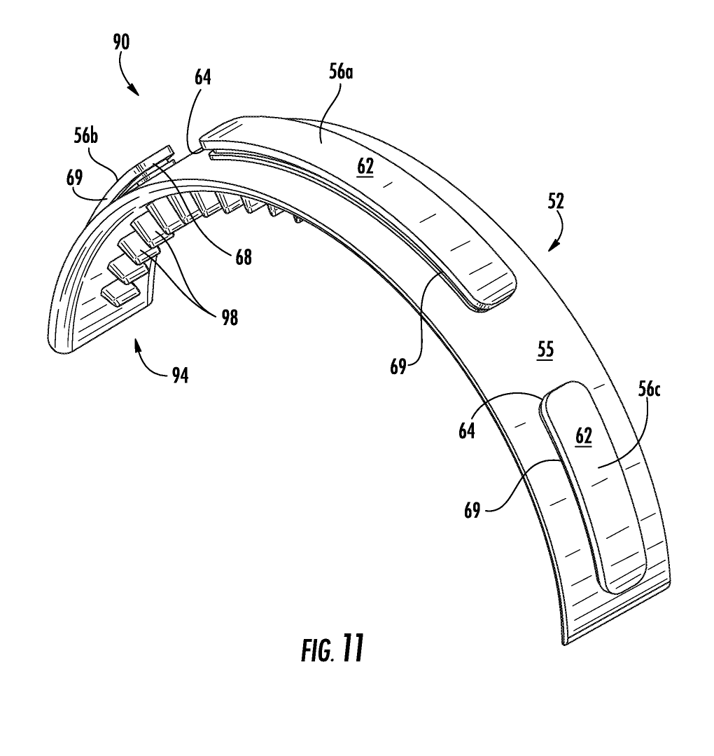

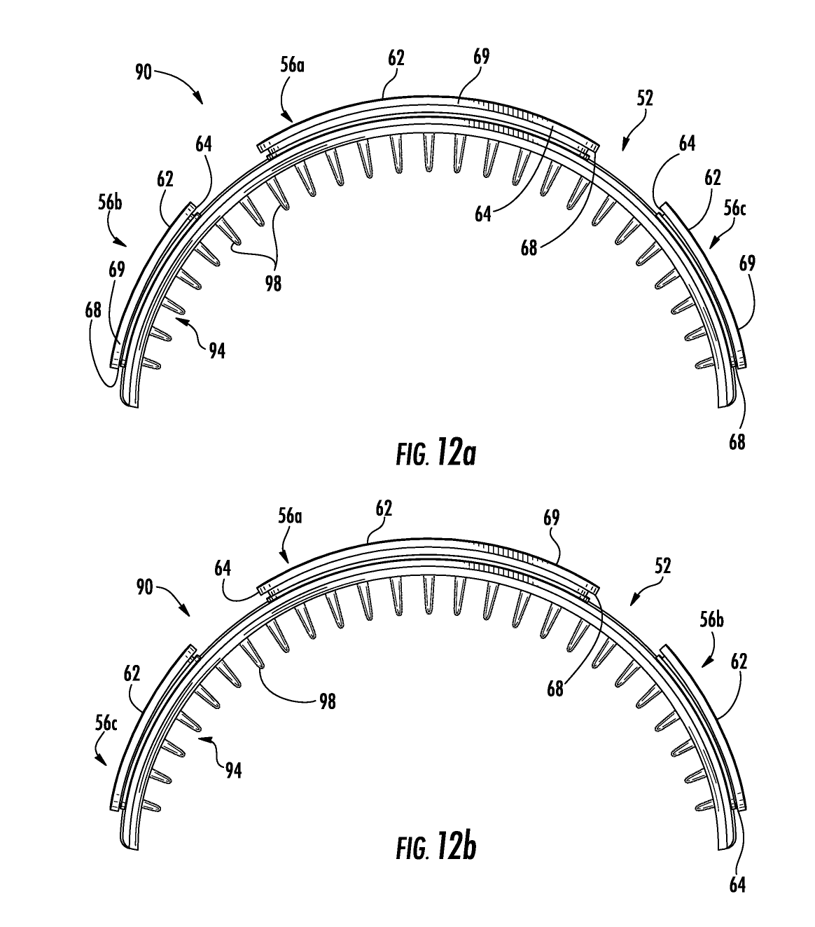

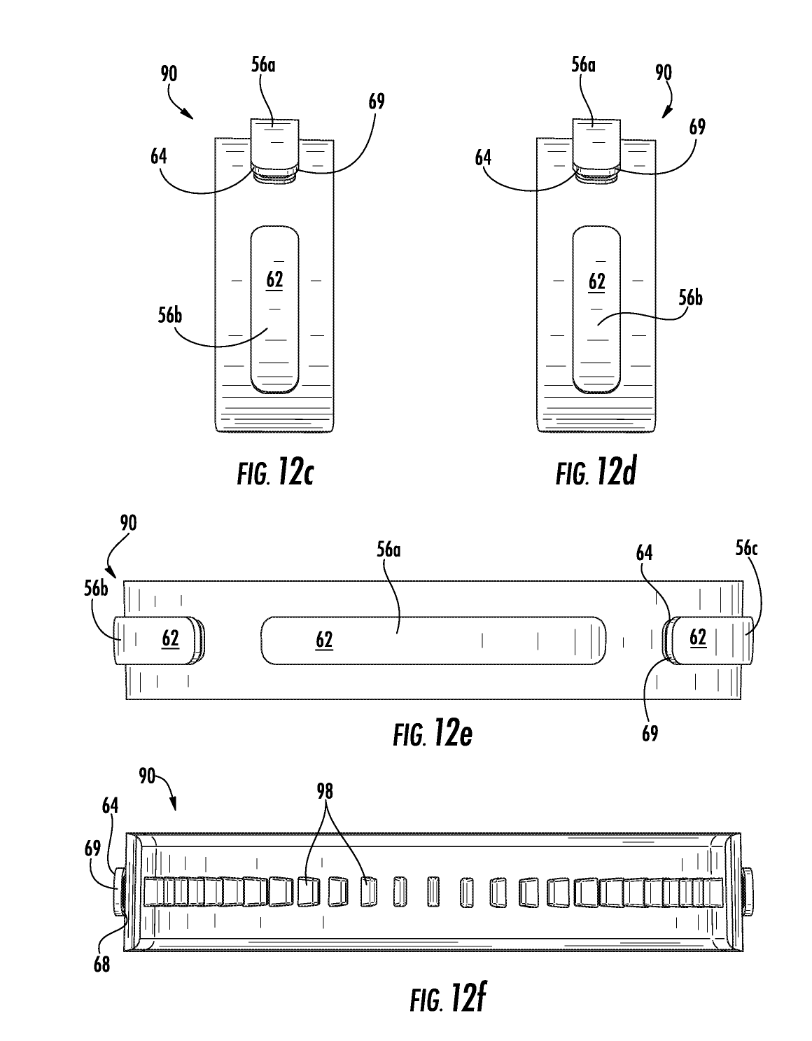

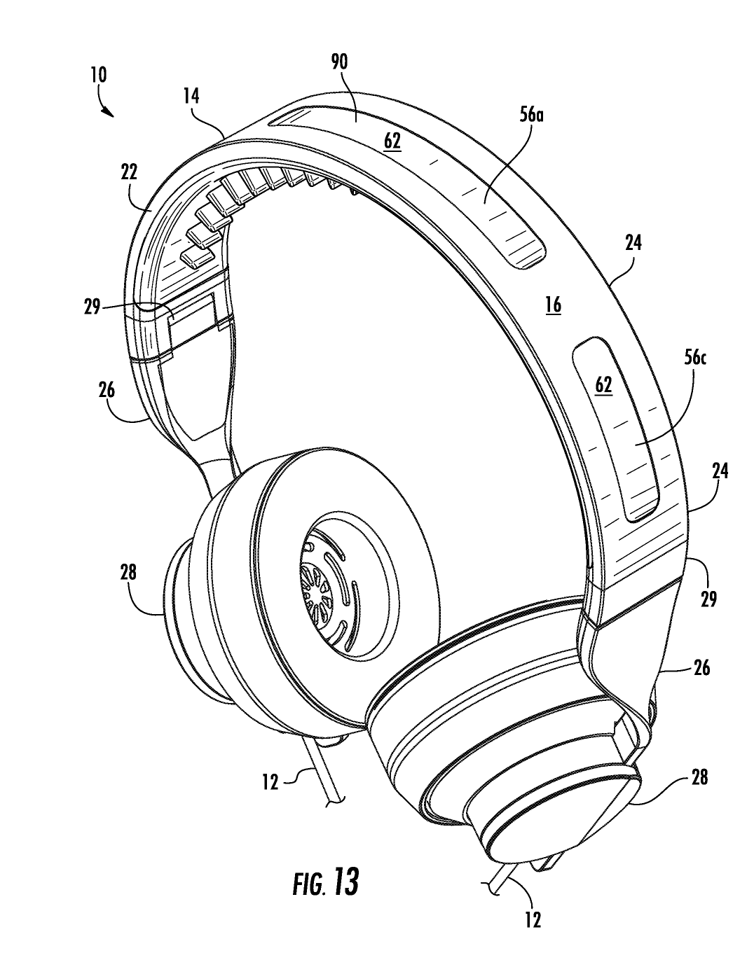

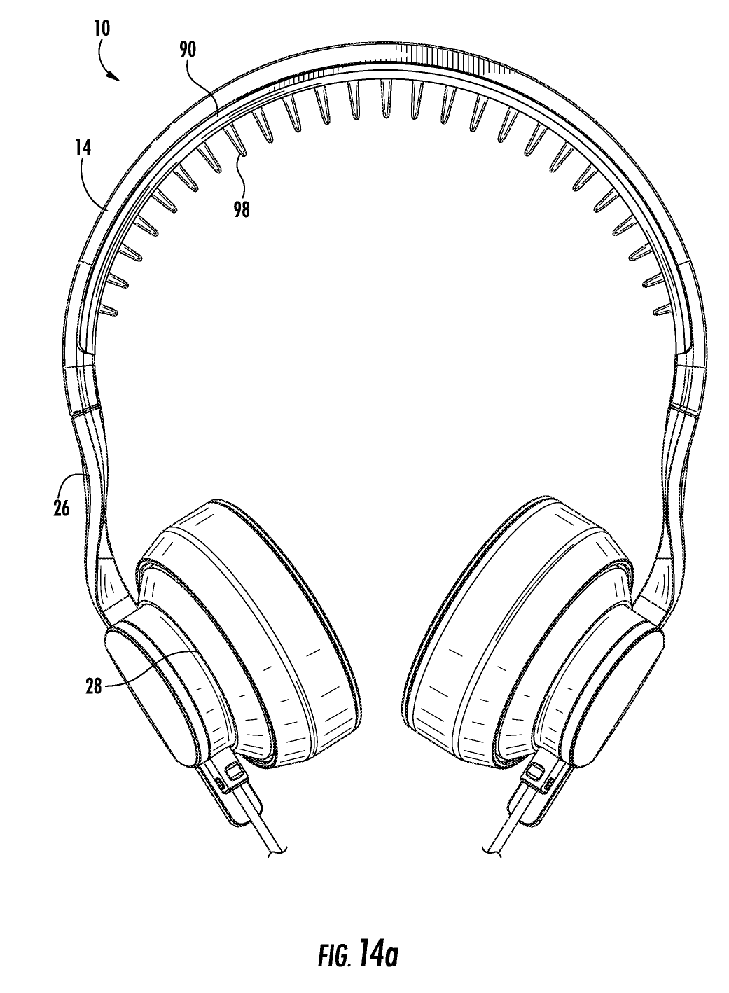

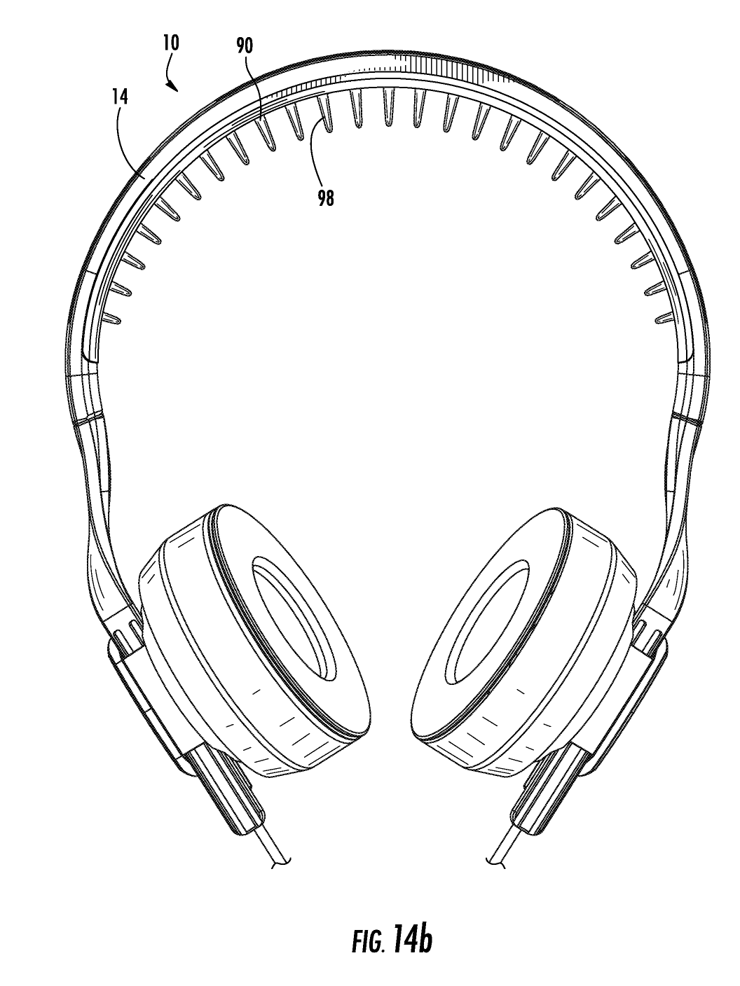

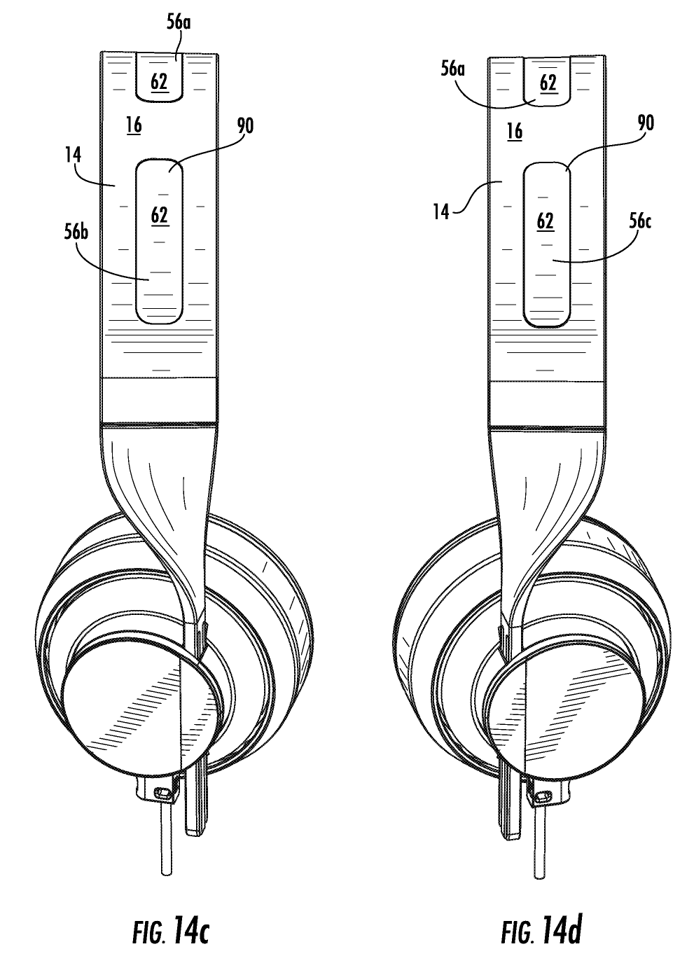

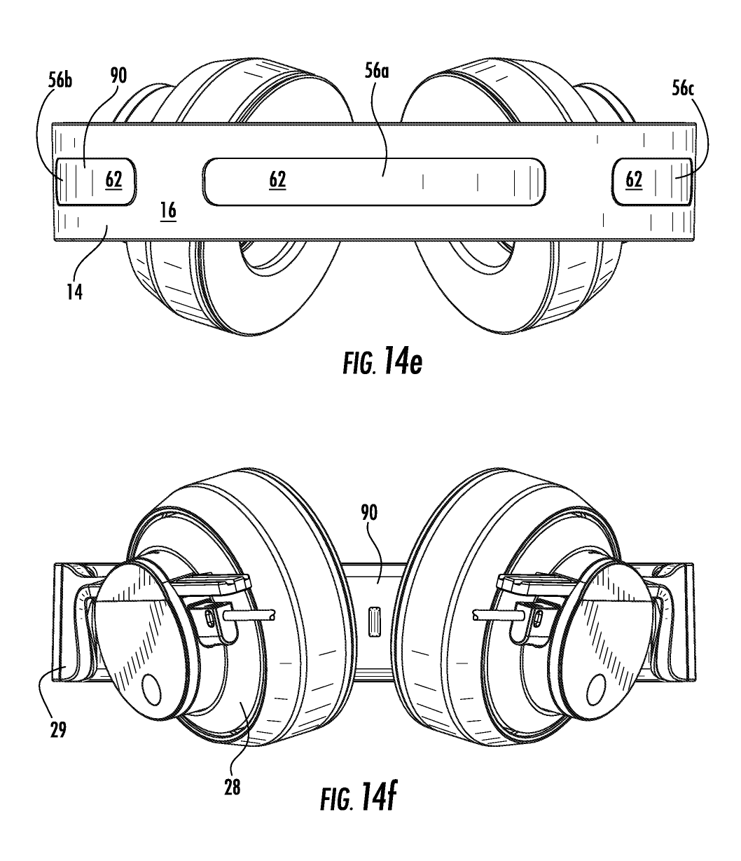

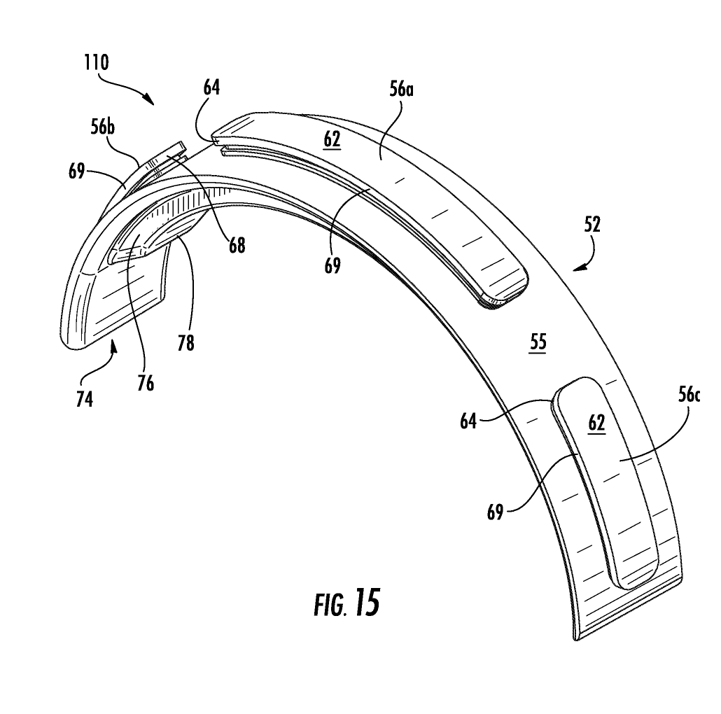

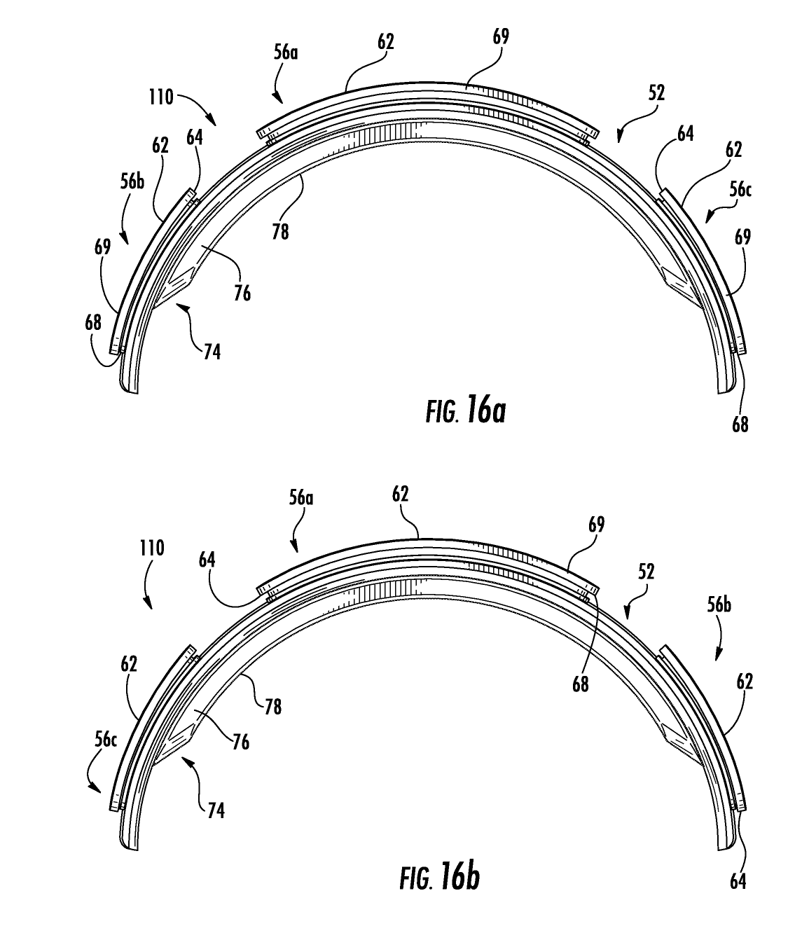

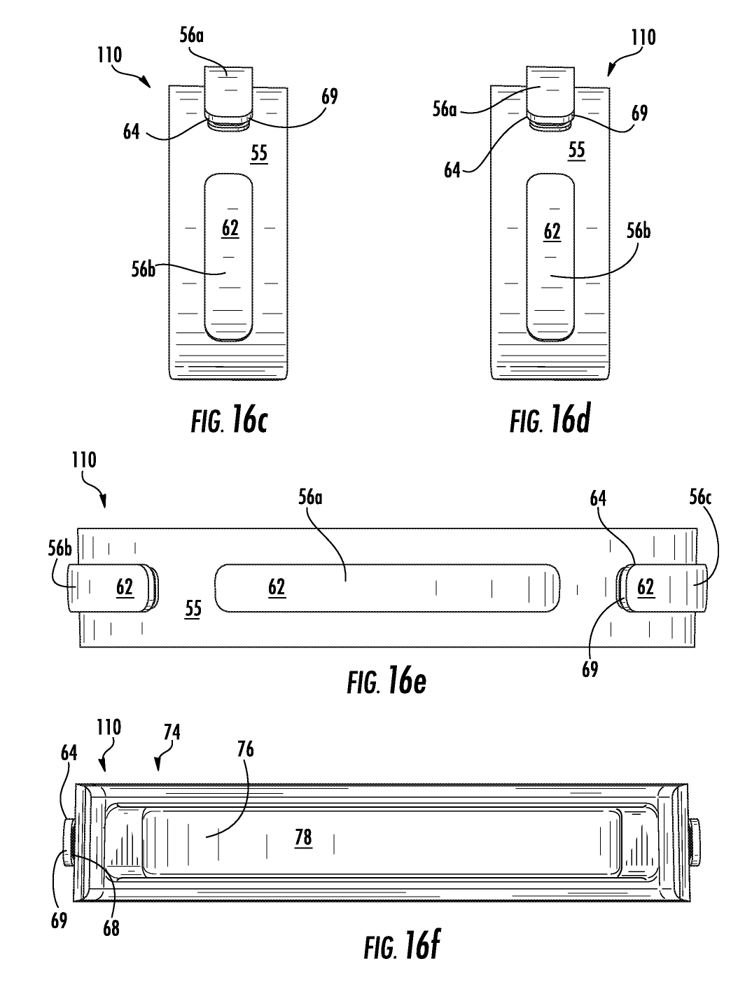

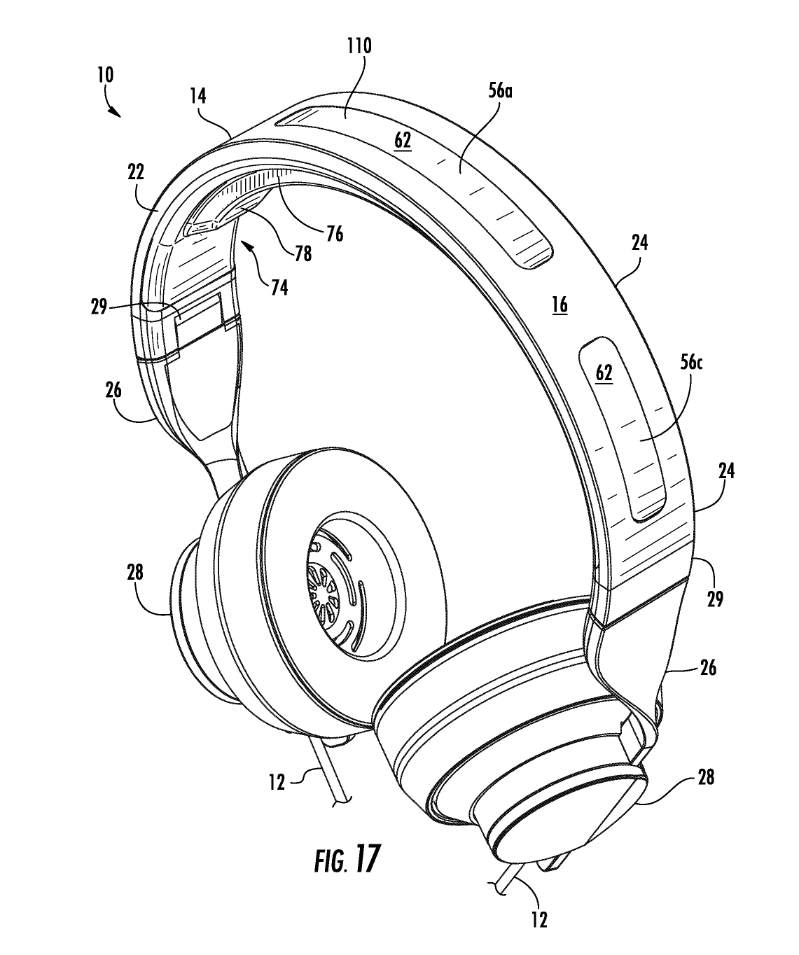

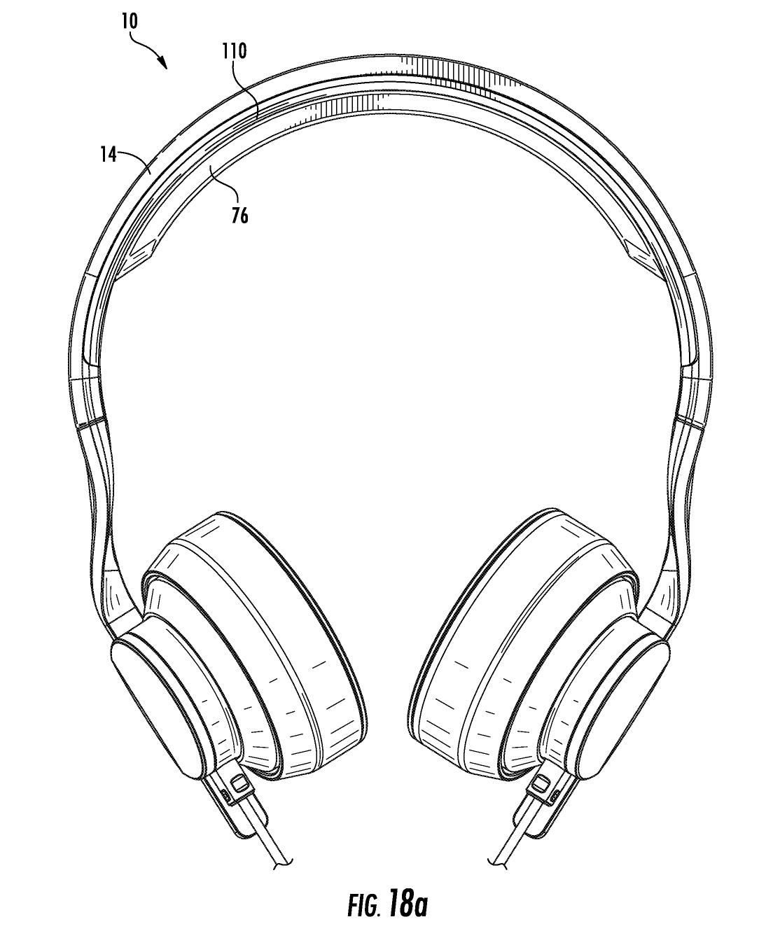

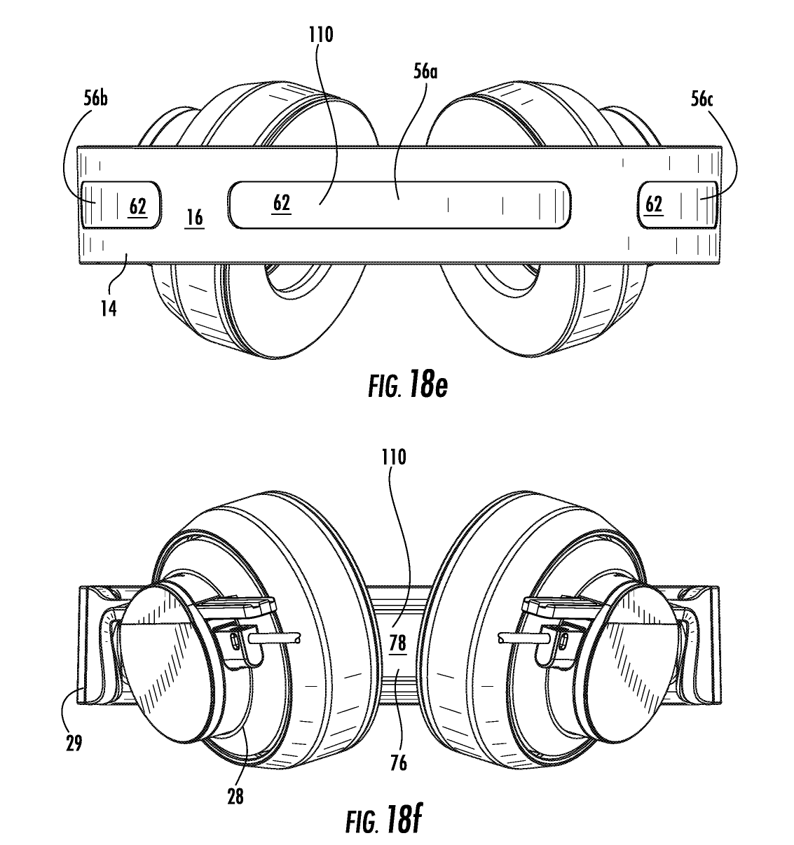

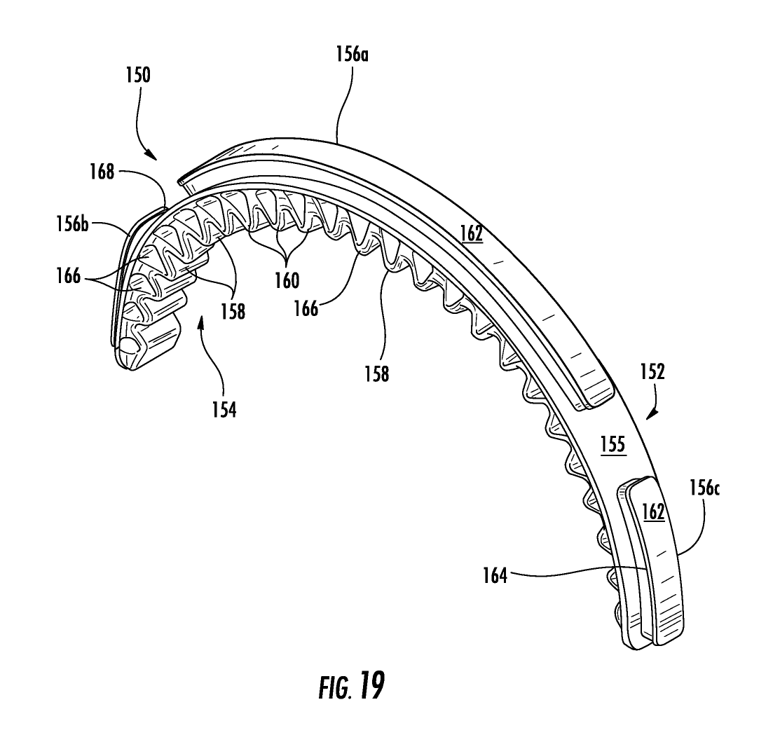

In bottom mounted interchangeable head-support inserts 50, 90, and 110 in embodiments illustrated in FIGS. 7-10, FIGS. 11-14, and FIGS. 15-18, the upper section 52 may be formed to detachably secure the interchangeable head-support inserts 50, 90, and 110 to the headband 14 when mounted. Each of these embodiments of bottom mounted interchangeable head-support inserts 50, 70, and 90 may be adapted to the headband 14 embodiment illustrated in FIG. 1b. Each could also be configured to be affixed to any headband 14 design described herein or known to one of ordinary skill in the art.

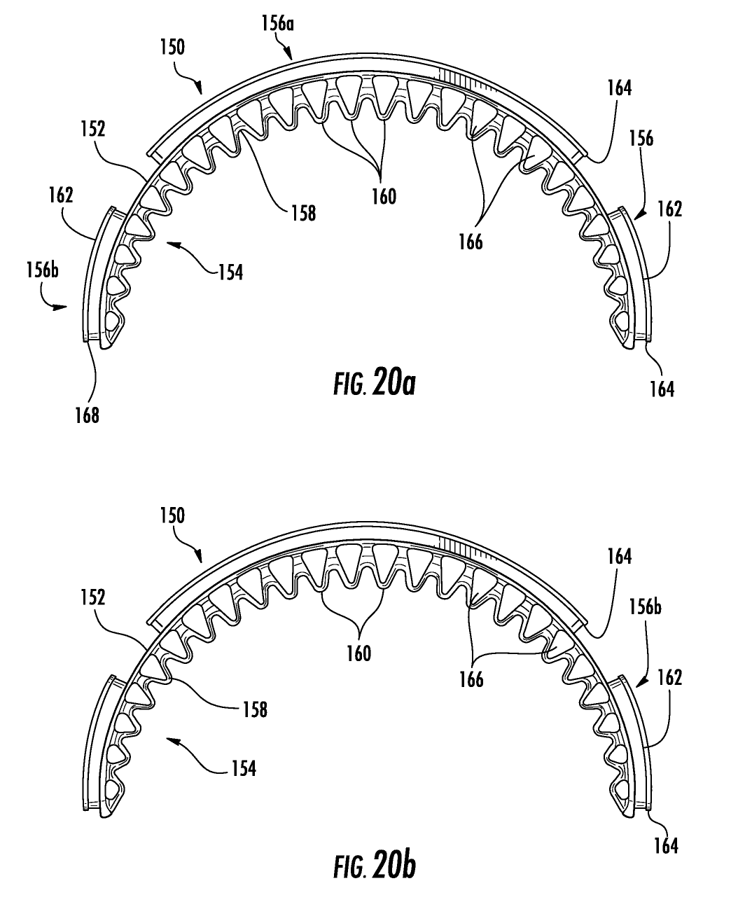

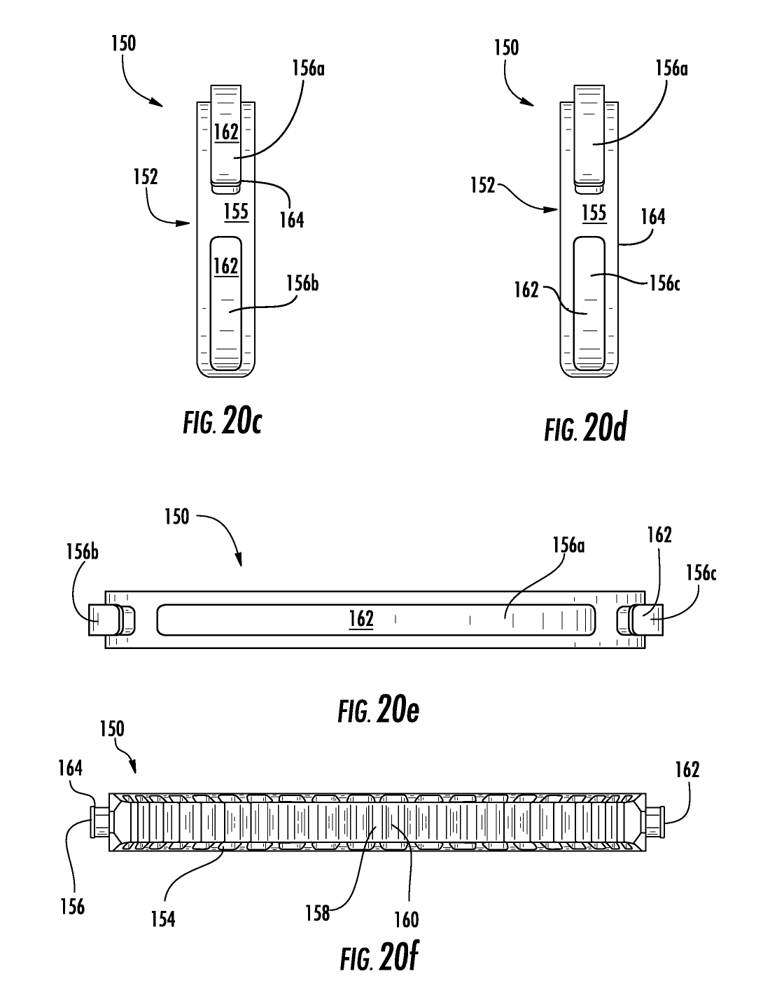

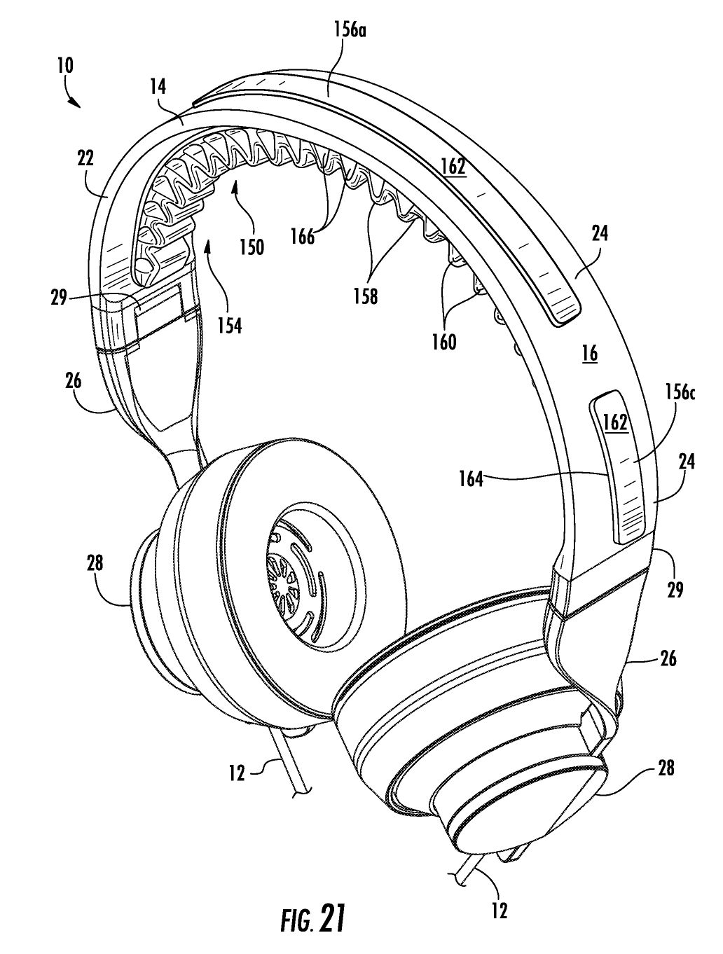

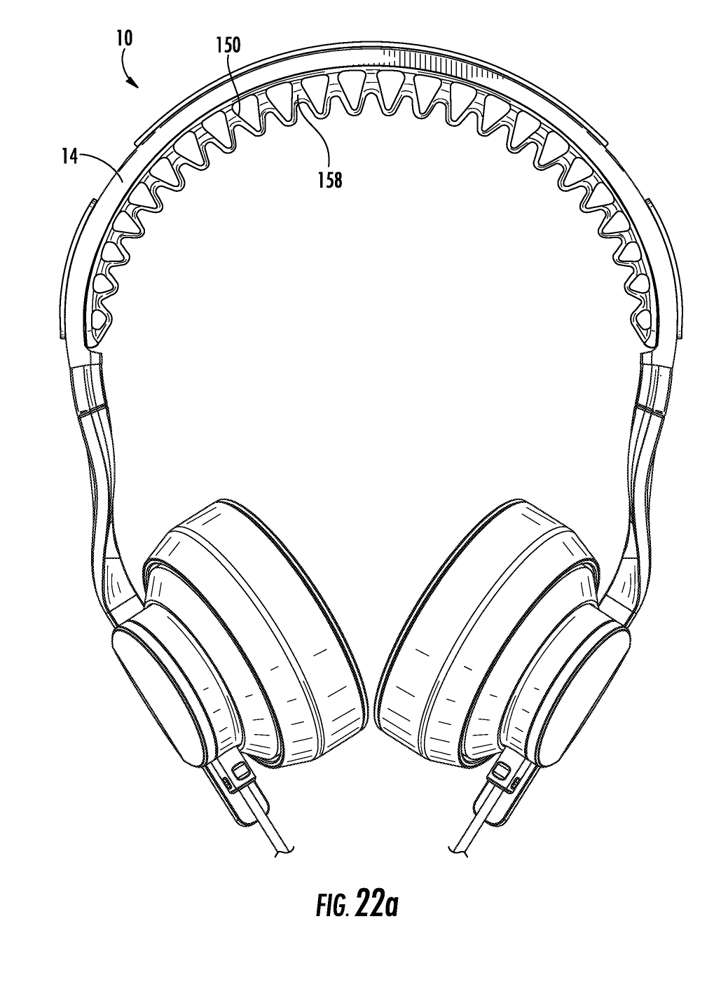

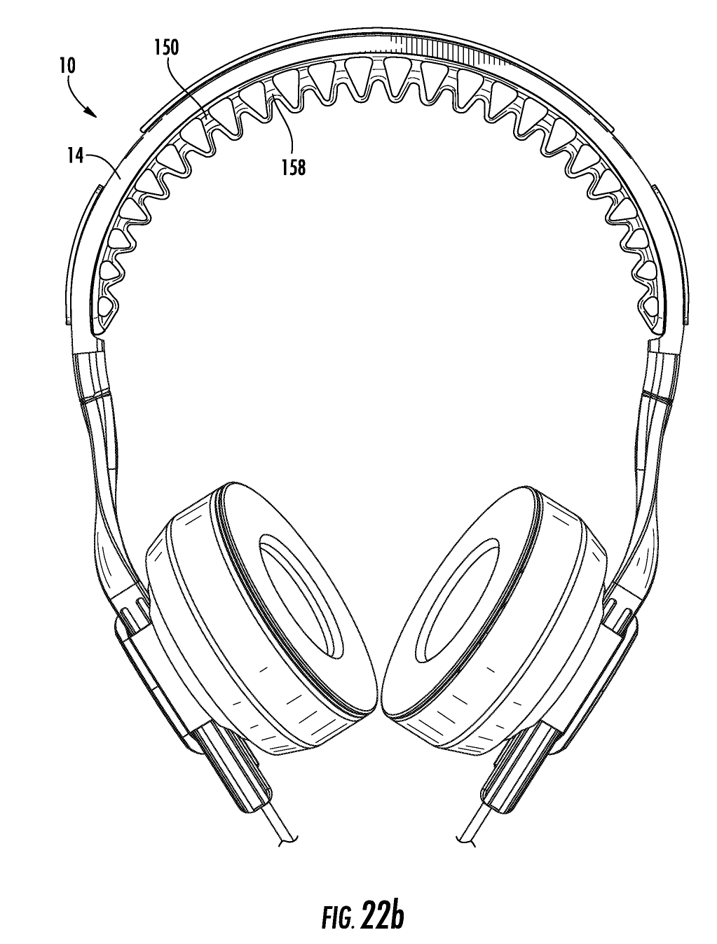

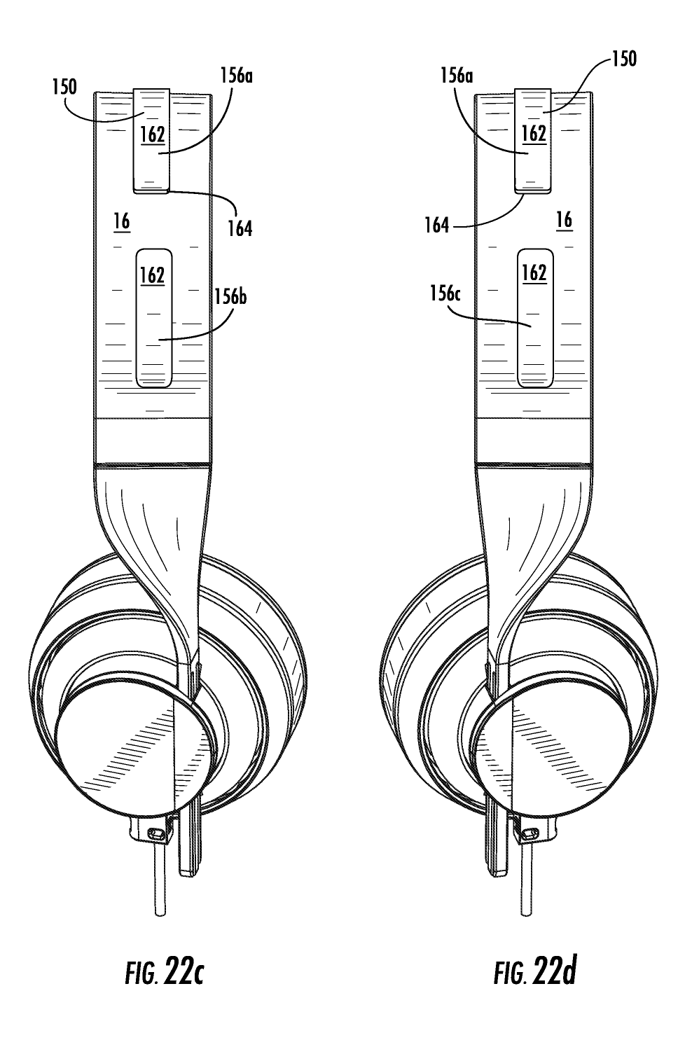

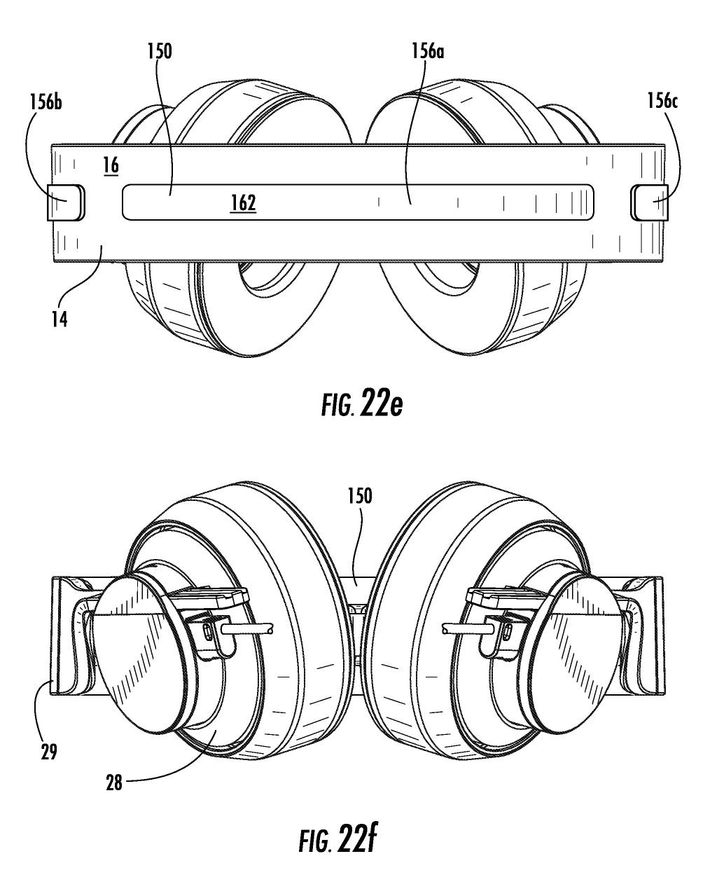

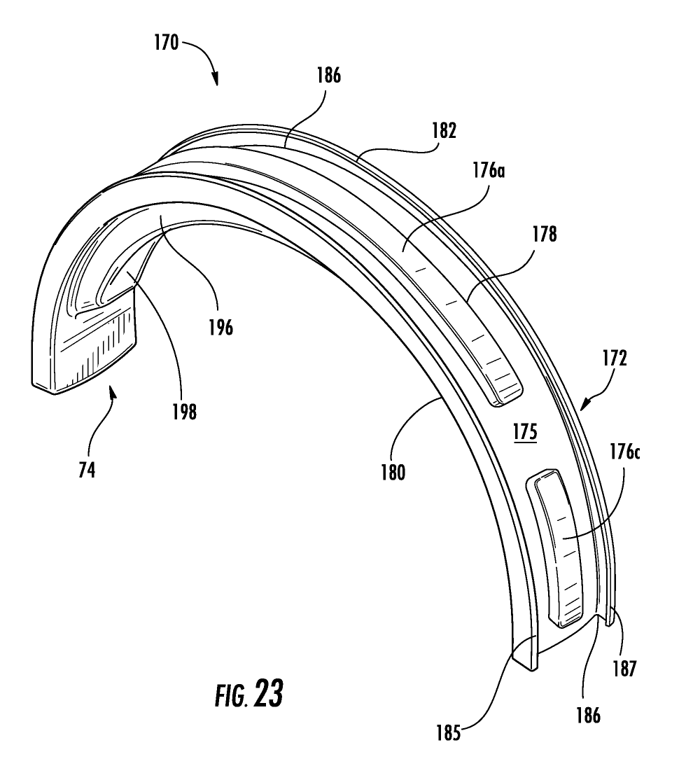

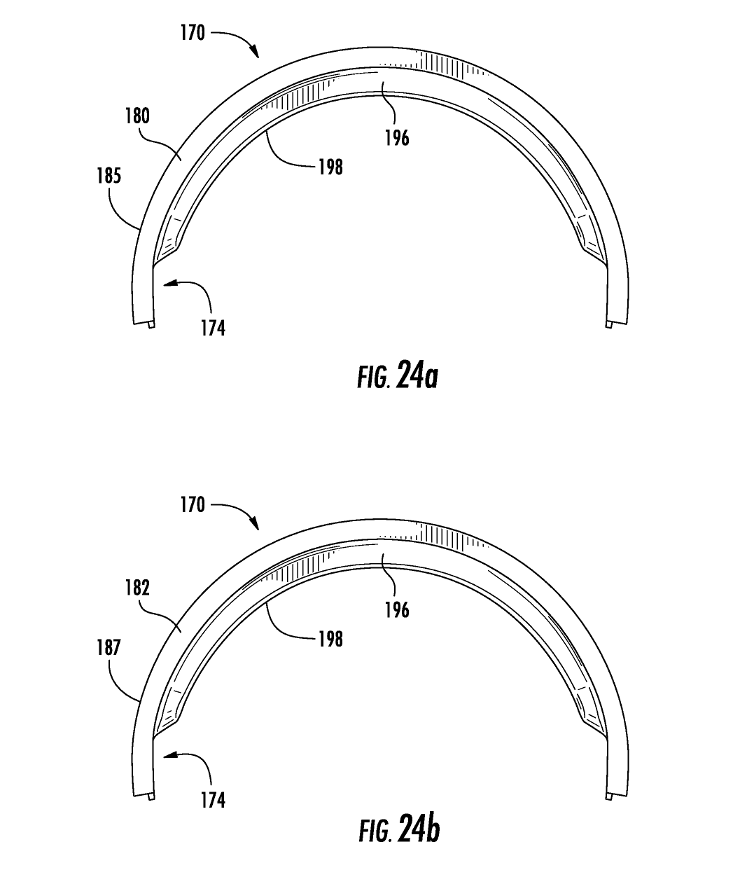

For example. in another embodiment, bottom mounted interchangeable head-support insert 150 illustrated in FIGS. 19-22 may have an upper section 152 adapted to detachably secure insert 150 to the headband 14 embodiment illustrated in FIG. 1a.

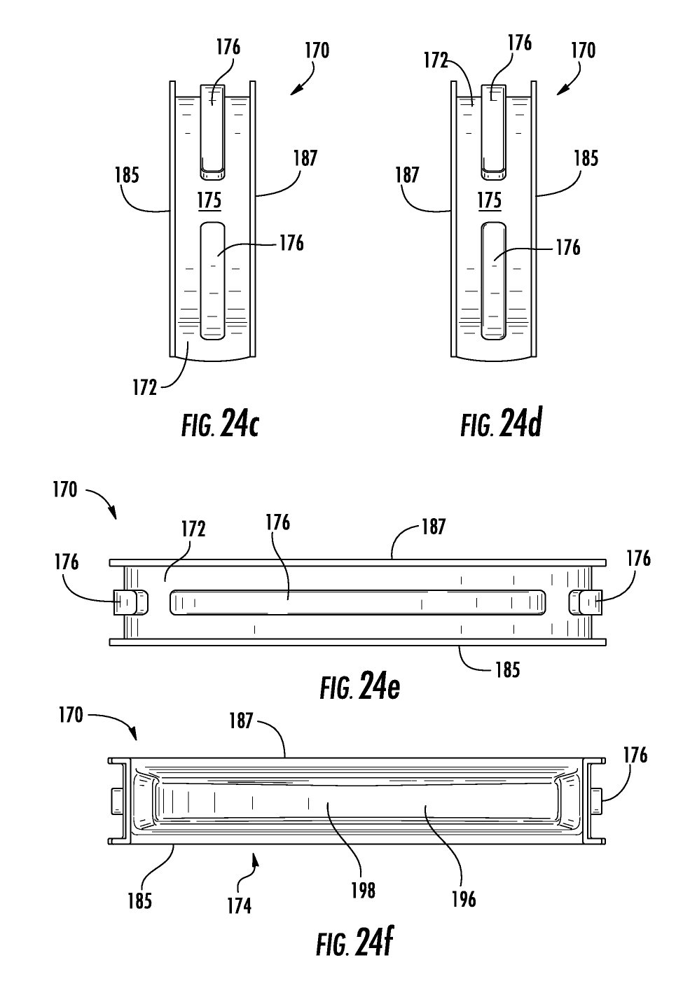

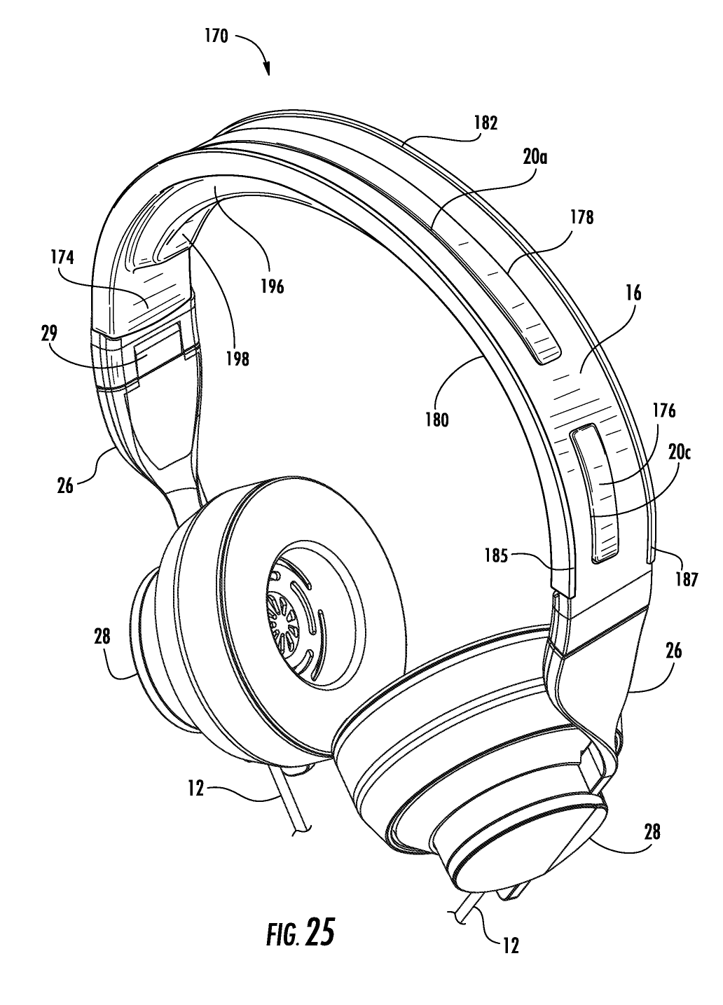

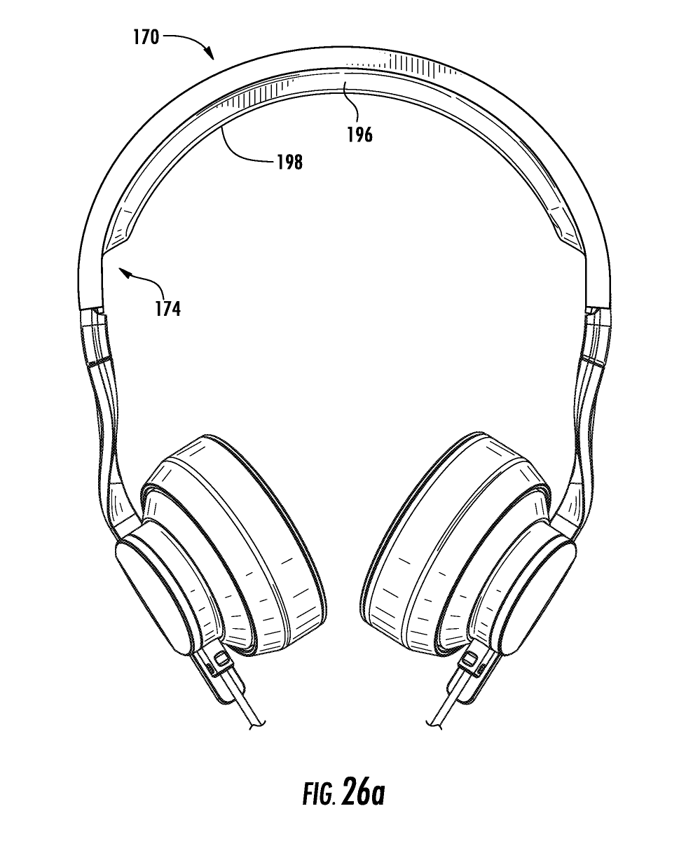

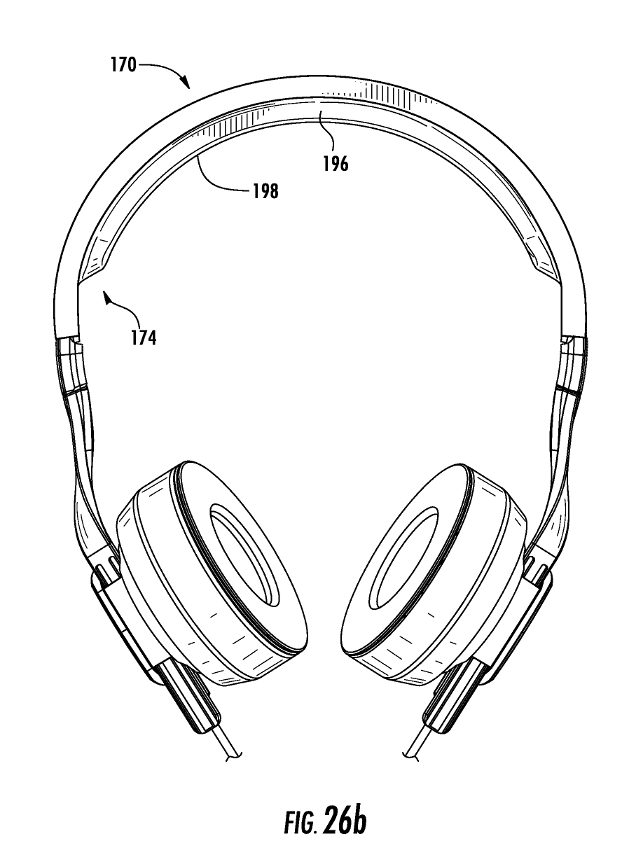

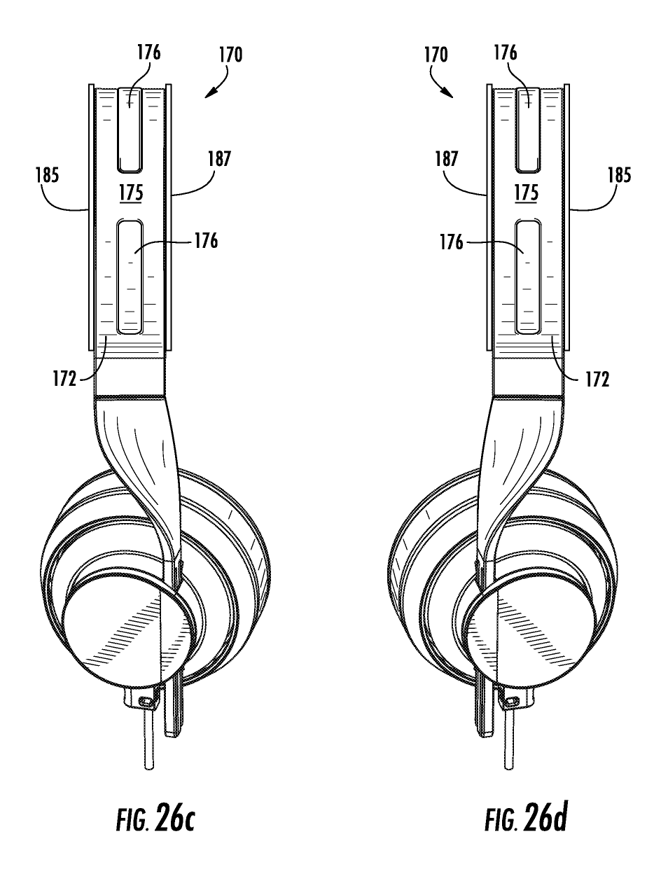

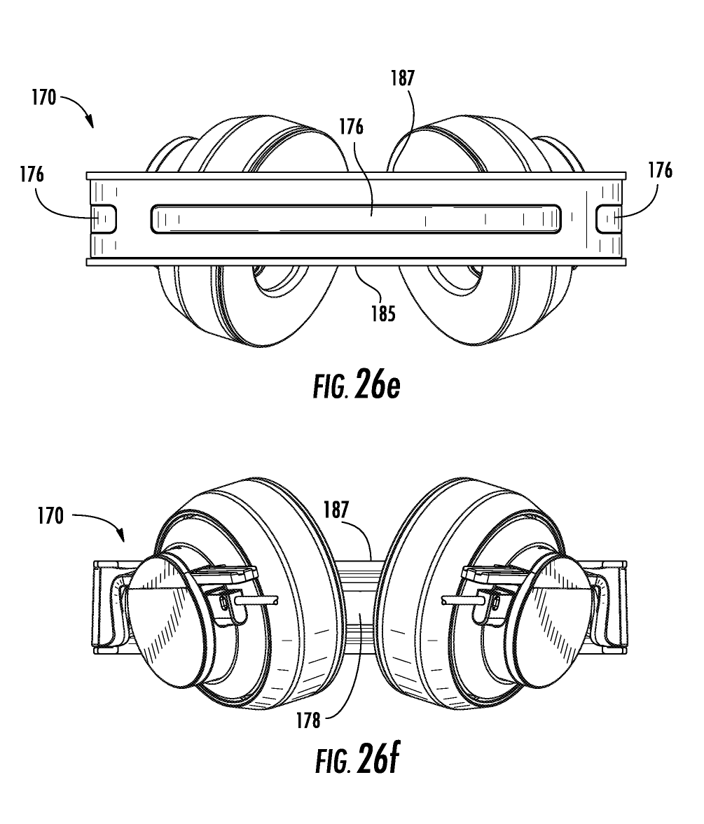

In yet another embodiment, bottom mounted interchangeable head-support insert 170 illustrated in FIGS. 23-26 demonstrates yet another way a bottom mounted insert may be detachably secured to the embodiments of headband 14 illustrated in FIGS. 1a, 1b, or other embodiments of a headband 14 known to one of ordinary skill in the art.

Each of the embodiments of bottom mounted inserts may have various designs for a lower section support that may comprise the part of the headphone assembly 10 that contacts the user's head and act as the support of the headphone assembly 10 while worn by a user. These designs of lower supports are not limited to the designs shown, but may be of any design known to one of ordinary skill in the art. Further, the lower supports illustrated are not limited to be used with the particular embodiments of headband 14 or methods of detachably securing an insert to a headband as illustrated.

Referring to bottom mounted interchangeable head-support insert 50 illustrated in FIGS. 7-10 an upper section 52 of the insert 50 may comprise three protrusions 56a-c configured to be accepted by openings 20a-c. When mounted, the protrusions 56 may extend from below the lower surface 18 of the headband 14 into the openings 20a-c in the headband. The protrusions 56 of upper section 52 may contact the inner surfaces 19a-c defining the openings 20a-c of the headband 14. If the protrusions 56 are made of a compressible material, this contact may form a compression-like fit to detachably secure the interchangeable head-support insert 50 to the headband 14 when mounted. While a less compressible insert could be similarly detachably secured by forming a friction or compression like fit with surfaces 19a-c.

In FIGS. 7-10, FIGS. 11-14, and FIGS. 15-18, the protrusions 56 are sized to fit within openings 20 to form a fit (e.g., a friction or compression fit) to detachably secure the insert 50, 90 or 110. The exact nature of the fit may depend on the pliability and frictional coefficient of the materials used for the bottom mounted interchangeable head-support insert 50, 90, or 110 and the headband 14. It is contemplated that the fit may be sufficient to maintain the insert in the headband 14 during use, but provide a user the ability to remove and reinsert the detachable head-support insert 50, 90, or 110. Each protrusion 56 may be also sized to fill a corresponding opening 20.

Referring further to bottom mounted interchangeable head-support inserts 50, 90, and 110 in embodiments illustrated in FIGS. 7-10, FIGS. 11-14, and FIGS. 15-18, an upper section 52 may be formed to detachably secure inserts 50, 90, and 110 respectively to the headband 14 embodiment illustrated in FIG. 1b. Protrusions 56 that may be configured to extend upward through the openings 20 of the headband of inserts 50, 90, and 110 may each also comprise an upper surface 62. Inserts 50, 90, and 110 may be designed so that the upper surface 62 of a protrusion 56 may extend radially so that is has a greater cross-sectional area than a potion of the protrusion below it. This may allow protrusion 56 to contact each of inner surfaces 19′, 19″, and 19′″ in the headband embodiment of FIG. 1b. Protrusion 56 with a radially wider upper surface 62 may form a lip 64 which may have a lower surface 68 and a side surface 69 at an upper end of the protrusion. For clarity, insert 50 will be described, however similar elements for inserts 90 and 100 share the same element numbers.

When insert 50 is mounted, upper surface 62 may be higher or lower than upper surface 16 of the headband 14, but in an embodiment illustrated the surfaces 16 and 62 are flush with each other.

When a bottom mounted interchangeable head-support insert 50 is mounted, a lower surface 68 of the lip 64 surrounding the upper surface 62 of a protrusion 56 may contact of the horizontal inner surface 19″ of opening 20. Likewise, side surface 69 of lip 64 of the protrusion 56 may contact vertical inner surface 19′″ and vertical sides of the protrusions may contact vertical inner surface 19′. This contact, acting in conjunction with a top surface 55 of the lower section support 54 of a bottom mounted interchangeable head-support insert 50 pressing against the lower surface 18 of the headband 14, will provide a friction-like, or a click-like fit to detachably secure a bottom mounted interchangeable head-support insert 50 to the headband 14. The exact nature of the fit caused by the lip 64 and the lower section support 54 may depend on the pliability of the material used for the bottom mounted interchangeable head-support insert 50, and it is contemplated to be sufficient to maintaining the insert in the headband in use, but provide a user the ability to remove and reinsert a detachable head-support insert 50.

The bottom mounted interchangeable head-support inserts 90 and 110 in embodiments illustrated in FIGS. 11-14, and FIGS. 15-18 include upper sections 52 that may detachably secure the inserts 90 and 110 to the headband 14 embodiment illustrated in FIG. 1b as described above for with respect to insert 50.

With respect to bottom mounted interchangeable head-support inserts 150 in an embodiment illustrated in FIGS. 19-22, an upper section 152 may be adapted to detachably secure the interchangeable head-support inserts 150 when mounted to the headband 14 embodiment illustrated in FIG. 1a. Referring to the embodiment illustrated in FIGS. 19-22, the protrusions 156 are configured to extend upward through the openings 20 of the headband 14. Protrusion 156 may have an upper surface 162 and protrusion 156 is configured to a length so that its upper surface 162 may extend above the upper surface 16 of the headband 14 when insert 150 is mounted.

The upper surface 162 of the protrusions 156 may also extend radially beyond the inner surfaces 19 of the headband 14 that define the openings 20, forming a lip 164 radially larger than the perimeter of the openings. When a bottom mounted interchangeable head-support insert 150 is mounted, a lower surface 168 of the lip 164 surrounding the upper surface 162 of a protrusion 156 may contact of the upper surface 16 of the headband 14. This contact, acting in conjunction with a top surface 155 of the lower section support 154 of a bottom mounted interchangeable head-support insert 150 pressing against the lower surface of the headband 14, will provide a friction-like, or a click-like fit to detachably secure a bottom mounted interchangeable head-support insert 150 to the headband 14. The exact nature of the fit caused by the lip 164 and the lower section support 154 may depend on the pliability of the material used for the bottom mounted interchangeable head-support insert 150, and it is contemplated to be sufficient to maintaining the insert in the headband in use, but provide a user the ability to remove and reinsert a detachable head-support insert 150.

FIGS. 23-26 illustrate another embodiment of a bottom mounted interchangeable head-support insert 170 that is configured to be mountable from below the headband 14. In this embodiment, the bottom mounted interchangeable head-support insert 170 may comprise a lower section support 174 that comprises the part of the headphone assembly 10 that contacts the user's head and act as the support of the headphone assembly 10 while worn by a user. An upper section 172 may comprise protrusions 176 that extend from below the lower surface 18 of the headband 14 through the openings 20 when mounted on the headband 14 and may detachably secure the bottom mounted interchangeable head-support insert 170 to headband 14.

The head support insert 170 may also be attached to a headband 14 of the headphone assembly 10 in a variety of ways. Referring to the bottom mounted interchangeable head-support insert 170 illustrated in FIGS. 23-26, the upper section 172 may be formed to detachably secure the interchangeable head-support insert 170 to the headband 14 when mounted. The upper section 172 may contact the inner surfaces 19a-c defining the openings 20a-c of the headband 14. This contact, acting in conjunction with a top surface 175 of the lower section support 174 of a bottom mounted interchangeable head-support insert 170 pressing against the lower surface of the headband 14, will provide a friction-like, or a click-like fit to detachably secure a bottom mounted interchangeable head-support insert 170 to the headband 14. If the protrusions 176 are made of a compressible material, this contact may form a compression-like fit to detachably secure the interchangeable head-support insert 170 to the headband 14 when mounted. While a less compressible insert could be similarly detachably secured by forming a friction or compression like fit with surfaces 19.

In FIGS. 23-26, the protrusions 176 are sized to fit within openings 20 to form a fit (e.g. a friction or compressions fit) to detachably secure the insert 170. The exact nature of the fit may depend on the pliability and frictional coefficient of the materials used for the bottom mounted interchangeable head-support insert 170 and the headband 14. It is contemplated that the fit may be sufficient to maintain the insert in the headband 14 during use, but provide a user the ability to remove and reinsert the detachable head-support 170. The protrusions 176 may be adapted to affix to the headband illustrated in FIG. 1a or 1b or other designs considered by one of skill in the art. As with the above embodiments, the embodiment in FIGS. 23-26 is illustrative of the variety of ways an insert may be attached to a headband 14 of the headphone assembly 10.

The upper section 172 of the bottom mounted interchangeable head-support insert 170 illustrated in FIGS. 23-26 may also be formed to detachably secure the interchangeable head-support insert 170 to the headband 14 when mounted in another way. The upper section 172 of the insert 170 may comprise a front edge 180 and a rear edge 182 that may overlay and envelop the front and rear edges 22,24 of the headband 14. The upper section 172 may comprise grooves or channels 184, 186 along and above the front and rear edges 180,182 of the insert 170 which can accommodate the front and rear edges 22,24 of the headband 14, respectively when mounted. Channels 184,186 may be formed in part by a lip 185,187 that protrudes inward from the front and rear edges 180,182 of the insert 170 and surface 175 of lower support 174 and extend along the upper surface 16 of the headband 14 on both the front and rear edges 180,182 of the insert 170 when mounted. The upper section front and rear channels 184,186 thus may serve to detachably secure the bottom mounted detachable head-support insert 170 in place on the headband 14.

A friction, click, compression, or other appropriate fit may also be formed by the interplay between front and rear channels 184,186 and the front and rear edges 22, 24 of the headband to detachably secure the interchangeable head-support insert 170 to the headband 14. The exact nature of the fit may depend on the pliability and frictional coefficient of the materials used for the bottom mounted interchangeable head-support insert 170 and the headband 14. It is contemplated that the fit may be sufficient to maintain the insert in the headband 14 during use, but provide a user the ability to remove and reinsert the detachable head-support insert 170.

### Head Cushions

In the embodiment illustrated in FIGS. 3-6, an interchangeable head-support insert 30 is shown to be insertable from above the headband 14. In such top-mounted insert embodiments, downward extending protrusions 36, which extend through headband openings 20, may also comprise the part of the headphone assembly 10 that contacts the wearer's head and acts as the support for the headphone assembly 10 on a user's head while worn by a user.

However, in the bottom mounted insert embodiments illustrated in FIGS. 7-26 above, inserts 50, 90, 110, 150, and 170, may comprise insert upper-sections (52, 152, and 172) which may detachably mount and secure the insert to the headband 14, and may also have insert lower-sections (54, 94, 114, 154, 174, respectively) of various designs that may comprise the part of the headphone assembly 10 that contacts the user's head and act as the support of the headphone assembly 10 while worn by a user.

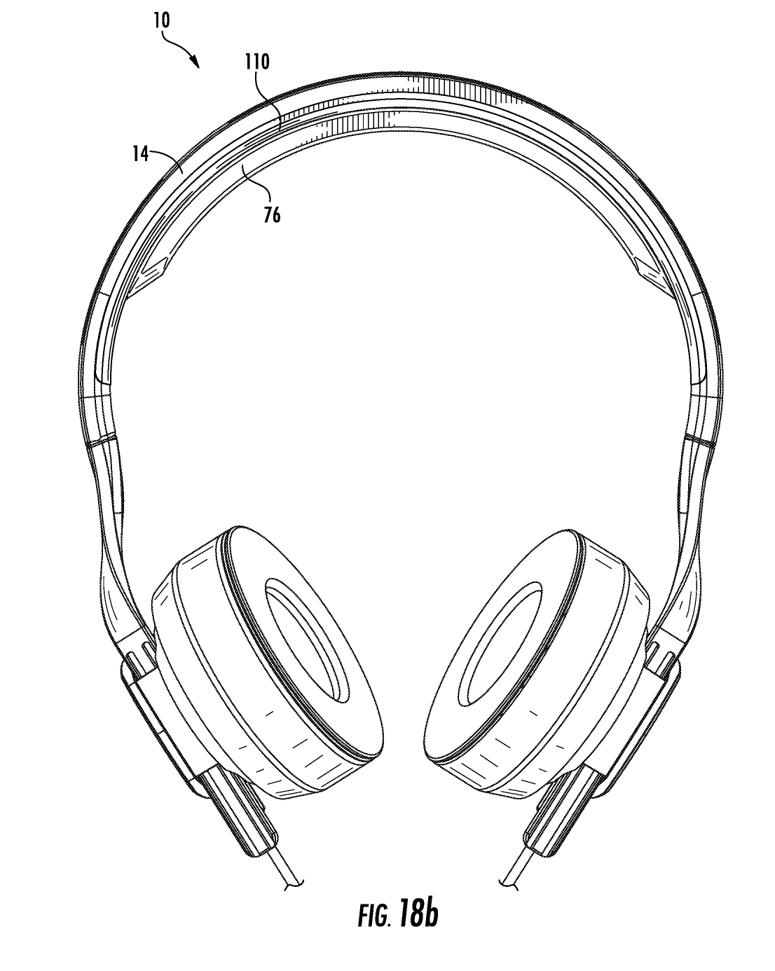

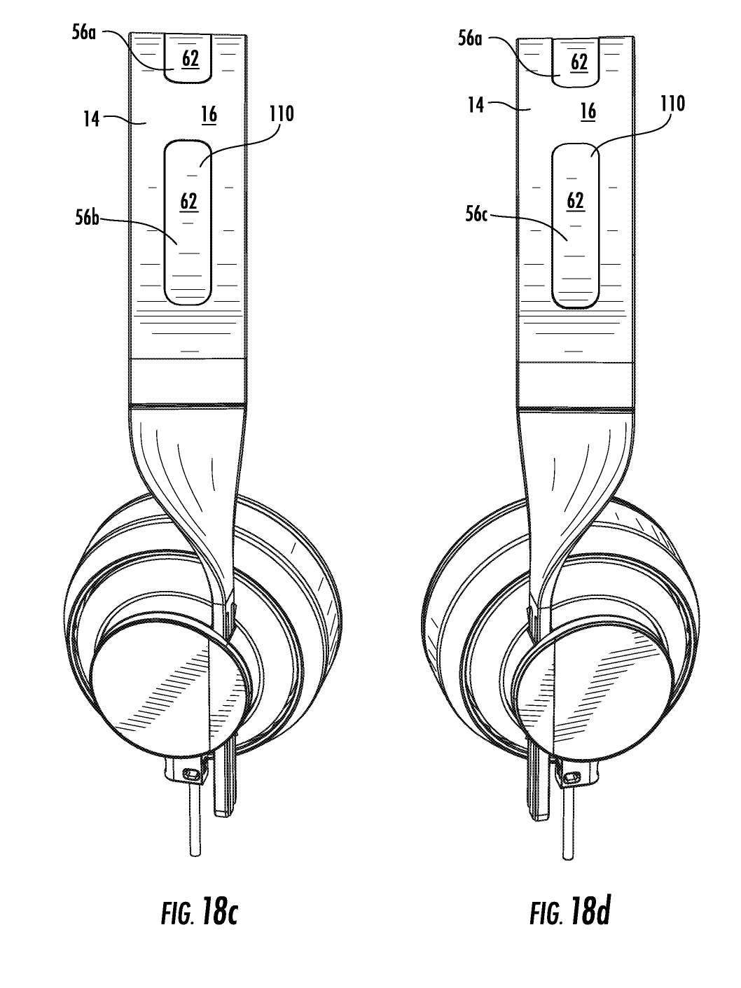

The designs of insert lower-supports illustrated generally in FIGS. 7-10, 11-14, 15-18, 19-22, and 23-26 are not limited to the designs shown, but may be of any design known to one of ordinary skill in the art. The insert lower supports illustrated in FIGS. 7-10, 11-14, and 19-22 provide examples of head supports comprising projections or extensions which may contact as users head, and the insert -lower supports illustrated in FIGS. 15-18 and 23-26 provide examples of head supports comprising a more traditional cushion style. Further, the lower supports illustrated are not limited to be used with the particular embodiments of headband 14, of insert upper-sections (52, 152, and 172) or methods of detachably securing an insert to a headband as illustrated.

Referring to the embodiment illustrated in FIGS. 7-10, an insert 50 may comprise an insert lower-section 54 that contacts the user's head and act as the support of the headphone assembly 10 while worn by a user. Insert lower-section 54 may comprise projections or protrusions which may be configured to reduce user fatigue from wearing the headphones 10 for extended periods of time, or to maintain a gap between the headband 14 and a user's head to minimize disturbance to a user's styled hair or to provide cooling or ventilation to the scalp. These effects may be achieved by the design choice in forming the lower section support 54 of a bottom mounted interchangeable head-support insert 50.

In FIGS. 7-10, the projections are formed in a shape similar in appearance to inverted ridges 58, providing contact points 60 for the support to rest on the user's head. Gaps 66 may also be provided for ventilation and heat dissipation, although the inverted ridged may also be solid without gaps. The inverted ridges 58 may be made of a pliant or flexible material so that the weight of the headband will rest gently on the contact points 60. In this embodiment, the ridges 58 may be made of a pliant material and may similarly maintain a distance between the headband 14 and a wearer's head to minimize disturbance to a wearer's styled hair. The resulting fit on a wearer's head may provide a wearer with extended periods of use while avoiding “headphone head” or a flattening of one's hairstyle. At the same time, the space provided by the gaps 66 may provide added comfort to a user by allowing air to circulate. The depth, shape, spacing and pliancy of the inverted ridges 58 may be considered by a designer of a head-support insert 50 to allow a user to achieve a desired comfort, fashion, appearance and style in its headphones.

Referring to the embodiment illustrated in FIGS. 19-22, an insert 150 may comprise an insert lower-section 154 that also may act as the head support of the headphone assembly 10 while worn by a user. Insert lower-section 154 may comprise projections or protrusions also in a shape similar to inverted ridges 58 illustrated in FIGS. 7-10. Inverted ridges 158 may provide contact points 160 for the insert 150 to rest on the user's head, and where provided, gaps 166 to ventilate and dissipate heat from a user's head.

The protrusions or extensions that act as the head supports may reach substantially from the front edge of the headband 22 to the rear edge 24 as the inverted ridges 58 in FIGS. 7-10 illustrate, or they may have a smaller width as the inverted ridges 158 in FIGS. 19-22 illustrate.

Referring to the embodiment illustrated in FIGS. 11-14, an insert 90 may comprise an insert lower-section 94 that contacts the user's head and act as the support of the headphone assembly 10 while worn by a user. Insert lower-section 94 may comprise projections or protrusions which may also be configured to reduce user fatigue from wearing the headphones 10 for extended periods of time, or to maintain a gap between the headband 14 and a user's head to minimize disturbance to a user's styled hair or to provide cooling ventilation. In FIGS. 11-14, the projections are formed in a shape similar in appearance to the teeth of a comb 98. The teeth 98 used in an embodiment with a bottom mounted insert 90 may have a similar effect on a user's head as the teeth 38 used in a top-mounted insert 30 illustrated in FIGS. 3-7.

The teeth 98 on insert 90 may be made of a pliant or flexible material so that the weight of the headband may rest on the tips of the teeth. This may allow the headband to be suspended above the user's head. In this embodiment, the teeth made of a pliant material may maintain a desired distance between the headband and a user's head to minimize disturbance to a user's styled hair. The resulting fit may provide a user with extended periods of use while avoiding “headphone head”. The depth, shape, spacing and pliancy of the teeth 98 may be considered by a designer of a head-support insert to allow a user to achieve a desired comfort, fashion, appearance and style in its headphones. For example, different comb lengths may be applied also to accommodate different hairstyles.

The teeth 98 of insert 90 are also contemplated to be made of a hard or inflexible material and interact with a user's hair in a similar fashion to a combed headband fashion accessory. In this case, the headphone headband could have the same effect on a user's hair as a typical hair accessory that may otherwise be chosen to be worn, and again avoiding “headphone head”.

Referring to the embodiment illustrated in FIGS. 15-19, an insert 110 may comprise an insert lower-section 74 that contacts the user's head and act as the support of the headphone assembly 10 while worn by a user. The lower section support 76 may serve as the actual head-support for the user. Insert lower-section 74 may include a lower section support 76 which may be formed as a cushion for the headphone assembly 10 to rest on the user's head, providing a comfortable user experience. The support 76 may be configured to reduce user fatigue from wearing the headphones for extended periods of time.

In FIGS. 15-19, the lower section supports cushion 76 may have a support surface 78 that may make substantially complete contact with a user's head. The lower section support 76 may be formed to provide a soft and cushioned fit on a user's head or it may be formed to provide a firm and precise fit for a user or any other level of pliancy chosen by a designer. The resulting fit may provide a user with extended periods of use while providing a finished appearance of the headphone assembly.

Referring also to FIGS. 23-26, an insert 170 may comprise an insert lower-section 174 that contacts the user's head and act as the support of the headphone assembly 10 while worn by a user. The lower section support 196 may serve as the actual head-support for the user. Insert lower-section 174 may include a lower section support 176 which may be formed as a cushion for the headphone assembly 10 to rest on the user's head, providing a comfortable user experience. The support 196 may be configured to reduce user fatigue from wearing the headphones for extended periods of time.

In FIGS. 23-26, the lower section supports cushion 196 may also have a support surface 198 that may make substantially complete contact with a user's head. The lower section support 196 may be formed to provide a soft and cushioned fit on a user's head or it may be formed to provide a firm and precise fit for a user or any other level of pliancy chosen by a designer. The resulting fit may provide a user with extended periods of use while providing a finished appearance of the headphone assembly.

Supports 76 and 196, as well as the inverted ridges 58 and 158, and comb teeth 38 and 98, are illustrative of many contemplated design choices one of skill in the art could make to design the head-support of a detachable head-support insert. The shape, spacing and pliancy of the teeth, ridges, and cushions are design considerations. Different comb or ridge depths may be applied also to accommodate different hairstyles.

Head-supports of varying shape, size, material, and pliancy are contemplated to provide a user customizable comfort, fashion, appearance and style for its headphones.

Each the means of detachably securing the insert into the headband addressed herein, or otherwise known to one skilled in the art are contemplated being employed singularly or any combination thereof. Other means for attaching or connecting the head-support inserts 30, 50, 90, 110, 150, and 170to the headband 14 are not shown in the drawings, but could include tongue (or protrusions, tab, lips, projections, etc.) and slot (or, grooves, apertures, channels, recesses, depressions etc.) configurations, magnetic connections, fasteners, snaps, buttons, hook and loop material, or other physical locking mechanisms.

The materials chosen for the top mounted interchangeable head-support insert 30 or the bottom mounted interchangeable head-support inserts 50, 90, 110, 150, and 170 may vary in design choices by one of skill in the art, with consideration of comfort, fashion, appearance and appearance, and maintaining undisturbed hair styles. Considerations in choosing the materials of the inserts 30, 50, 90, 110, 150, and 170 may include the strength and flexibility of the chosen materials or of manufacturing ease. Other considerations may include the ease of insertion and removal of the interchangeable head-support inserts 30, 50, 90, 110, 150, and 170 by a user, and the stability of the mounted interchangeable head-support inserts 30, 50, 90, 110, 150, and 170 while in use. In an embodiment, the materials chosen for the interchangeable head-support inserts 30, 50, 90, 110, 150, and 170 will be capable of being washed by a user to maintain a clean and new appearance.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

What is claimed is:

1. A headphone assembly comprising:
a headband for reaching over a user's head and comprising a headband upper surface and a headband lower surface, and further comprising at least one opening between said headband upper surface and headband lower surface, said at least one opening comprising at least a first opening surface;
an insert detachably mounted to said headband;
said insert comprising at least one insert connector disposed within said at least one opening between said headband upper surface and headband lower surface and contacting said at least a first opening surface when said insert is detachably mounted to said headband; and
said insert further comprising an insert support disposed between said lower surface of said headband and said user's head when said headphone assembly is worn by said user.

2. The headphone assembly of claim 1, wherein said at least one opening between said headband upper surface and headband lower surface further comprises at least a second opening surface.

3. The headphone assembly of claim 1, wherein said insert connector contacts said at least second opening surface when said insert is detachably mounted to said headband.

4. The headphone assembly of claim 1, wherein said insert connector further comprises an insert connector lip at an end of said insert connector.

5. The headphone assembly of claim 1, wherein said insert connector lip contacts said upper headband surface when said insert is detachably mounted to said headband.

6. The headphone assembly of claim 1, wherein said insert connector lip contacts said at least a second opening surface when said insert is detachably mounted to said headband.

7. The headphone assembly of claim 1, wherein said at least a first opening surface is generally perpendicular to said headband upper surface.

8. The headphone assembly of claim 1, wherein said at least a second opening surface is generally parallel to said headband upper surface.

9. The headphone assembly of claim 1, wherein said insert support further comprising a plurality of protrusions extending from said insert support to contact said user's head and provide a gap between said headband and said user's head.

10. The headphone assembly of claim 1, wherein said insert support further comprises a cushion positioned to contact said user's head.

11. The headphone assembly of claim 1, wherein said insert is detachably mounted to said headband from below said lower surface of said headband.

12. The headphone assembly of claim 1, wherein said insert is detachably mounted to said headband from above said upper surface of said headband.

13. The headphone assembly of claim 1, wherein said at least one opening between said headband upper surface and headband lower surface further comprises:
at least a third opening surface;
wherein said insert connector contacts said at least third opening surface when said insert is detachably mounted to said headband; and
wherein said at least a third opening surface is generally perpendicular to said headband upper surface.

14. A headphone assembly comprising:
a headband for reaching over a user's head and comprising a headband upper surface and a headband lower surface, and further comprising at least one opening between said headband upper surface and headband lower surface, said at least one opening comprising at least a first opening surface; and
an insert detachably mounted to said headband.

15. The headphone assembly of claim 14, wherein said insert further comprising:
at least one insert connector disposed within said at least one opening between said headband upper surface and headband lower surface; and
at least one insert support disposed between said lower surface of said headband and said user's head when said headphone assembly is worn by said user.

16. The headphone assembly of claim 15, wherein said insert connector is disposed in said at least one opening and contacts said at least a first opening surface.

17. The headphone assembly of claim 16, wherein said at least a first opening surface is generally perpendicular to said headband upper surface.

18. The headphone assembly of claim 16, wherein said at least a first opening surface is generally parallel to said headband upper surface.

19. The headphone assembly of claim 15, wherein said insert support further comprising:
a plurality of protrusions extending from said insert support to contact said user's head and provide a gap between said headband and said user's head.

20. A headphone assembly comprising:
a headband for reaching over a user's head and comprising a headband upper surface and a headband lower surface, and further comprising at least one opening between said headband upper surface and headband lower surface, said at least one opening comprising at least a first opening surface;
a head support detachably mounted to said headband;
wherein said head support comprises at least one extension, said extension sized to fill said at least one opening between said headband upper surface and headband lower surface; and
wherein said head support further comprises a plurality of protrusions disposed between said lower surface of said headband and said user's head when said headphone assembly is worn by a user and provide a space between said headband and said user's head.
